(19) United States
(12) Patent Application Publication
(10) Pub. No.: US 2013/0216690 A1
(43) Pub. Date: Aug. 22, 2013

(54) AQUACULTURE MEAT PRODUCTS

(71) Applicant: E I DU PONT DE NEMOURS AND COMPANY, (US)

(72) Inventors: Scott E. Nichols, West Chester, PA (US); J. Martin Odom, Kennett Square, PA (US)

(73) Assignee: E I DU PONT DE NEMOURS AND COMPANY, Wilmington, DE (US)

(21) Appl. No.: 13/851,512

(22) Filed: Mar. 27, 2013

Related U.S. Application Data
(63) Continuation of application No. 13/208,050, filed on Aug. 11, 2011.
(60) Provisional application No. 61/372,587, filed on Aug. 11, 2010.

(51) Int. Cl. A23K 1/00; A23L 1/325

(52) U.S. Cl. CPC A23K 1/007; A23L 1/325
USPC 426/643; 119/230

(57) ABSTRACT

Aquaculture meat products having a ratio of omega-3 polyunsaturated fatty acids of eicosapentaenoic acid [“EPA”; cis-5,8,11,14,17-eicosapentaenoic acid; 20:5], to docosahexaenoic acid [“DHA”; cis-4,7,10,13,16,19-docosahexaenoic acid; 22:6], equal to or greater than 1.4:1 based on the individual concentrations of each as a percent of the total fatty acids in the aquaculture meat product are disclosed. Furthermore, such aquaculture meat products may have a concentration of the sum of EPA and DHA that is at least about 0.5%, measured as a weight percent of the aquaculture meat product.

This application claims the benefit of U.S. Provisional Application 61/372,587, filed Aug. 11, 2010, the disclosure of which is hereby incorporated by reference in its entirety.

### FIELD OF THE INVENTION

This invention is in the field of aquaculture. More specifically, this invention pertains to aquaculture meat products having higher ratios of eicosapentaenoic acid to docosahexaenoic acid than those currently found in commercial aquaculture meat products.

### BACKGROUND OF THE INVENTION

Fish are recommended in a human diet to provide a source of long chain omega-3 (ω-3 or n-3) polyunsaturated fatty acids [“PUFAs”]. The long chain omega-3 PUFAs eicosapentaenoic acid (EPA; cis-5,8,11,14,17-eicosapentaenoic acid; 20:5) and docosahexaenoic acid (DHA; cis-4,7,10,13,16,19-docosahexaenoic acid; 22:6) are well recognized as dietary components that may reduce the risk of coronary heart disease. Wild fish consume microalgae, or small fish that consume microalgae, as a source of EPA and DHA. The EPA and DHA are naturally incorporated and remain in the meat product that is sold for human consumption.

Aquaculture is an increasingly prevalent production system for providing fish and crustaceans for the human diet. Animals produced by aquaculture are fed formulated diets that provide protein, vitamin, mineral, and fatty acid components to replace a natural diet. EPA and DHA are essential fatty acids required for fish growth and health, as well as being desirable in an aquaculture product to support human health, and therefore are provided in feed compositions used in aquaculture. Marine fish oils have traditionally been used as the sole dietary lipid source in commercial fish feed given their availability, competitive price and the abundance of essential fatty acids including EPA and DHA.

It is estimated that aquaculture feed compositions currently use about 87% of the global supply of fish oil as a lipid source. Since annual fish oil production has not increased beyond 1.5 million tons per year, the rapidly growing aquaculture industry cannot continue to rely on finite stocks of marine pelagic fish as a supply of fish oil. Thus, there is great urgency to find and implement sustainable alternatives to fish oil that can keep pace with the growing global demand for fish products.

Many organizations recognize the limitations noted above with respect to fish oil availability and aquaculture sustainability. For example, in the United States, the National Oceanic and Atmospheric Administration is partnering with the Department of Agriculture in an Alternative Feeds Initiative to “ . . . identify alternative dietary ingredients that will reduce the amount of fishmeal and fish oil contained in aquaculture feeds while maintaining the important human health benefits of farmed seafood”.

U.S. Pat. No. 7,932,077 suggests recombinantly engineered Yarrowia lipolytica may be a useful addition to most animal feeds, including aquaculture feeds, as a means to provide necessary omega-3 and/or omega-6 PUFAs and based on its unique protein:lipid:carbohydrate composition, as well as unique complex carbohydrate profile (comprising an approximate 1:4:4.6 ratio of mannan:beta-glucans:chitin).

U.S. Pat. Appl. Pub. No. 2007-0226814-A1 discloses fish food containing at least one biomass obtained from fermenting microorganisms wherein the biomass contains at least 20% DHA relative to the total fatty acid content. Preferred microorganisms used as sources for DHA are organisms belonging to the genus Stramenopiles.

U.S. Pat. Appl. Pub. No. 2009-0202672-A1 discloses, inter alia, aquaculture feed incorporating oil obtained from a transgenic plant engineered to produce stearidonic acid [“SDA”; 18:4 omega-3]. However, SDA is converted with low efficiency to DHA in fish.

If the growing aquaculture industry is to sustain its contribution to world fish supplies while producing aquaculture meat products that continue to provide health benefits for human consumption, then a reduction in the use wild fish is needed along with the adoption of more ecologically-sound management practices of the world fish supply.

### SUMMARY OF THE INVENTION

In one embodiment the invention provides an aquaculture meat product comprising a ratio of eicosapentaenoic acid (EPA) to docosahexanoic acid (DHA) that is equal to or greater than 1.4:1, based on the individual concentrations of EPA and DHA in the aquaculture meat product. Preferably, the ratio of EPA to DHA is equal to or greater than 1.5:1 based on the individual concentrations of EPA and DHA in the aquaculture meat product.

In a second embodiment, the invention concerns the aquaculture meat product of the invention wherein the sum of EPA and DHA is at least 0.5 weight percent of the aquaculture meat product.

In a third embodiment, the invention concerns a method of producing an aquaculture meat product comprising:
a) providing an aquaculture feed comprising at least one source of EPA and, optionally, at least one source of DHA wherein said source can be the same or different;
b) feeding the aquaculture feed of (a) to fish; and,
c) harvesting an aquaculture meat product from the fish of (b); wherein the ratio of EPA to DHA in the aquaculture meat product of (c) is equal to or greater than 1.4 to 1 based on the individual concentrations of EPA and DHA in the aquaculture meat product.

Preferably, the at least one source of EPA is microbial oil and optionally fish oil.

In a fourth embodiment, the invention concerns a method of producing an aquaculture meat product wherein the microbial oil source of EPA in the aquaculture feed is provided in a form selected from the group consisting of biomass, processed biomass, partially purified oil and purified oil, any of which is obtained from at least one transgenic microbe engineered for the production of polyunsaturated fatty acid-containing microbial oil comprising EPA.

In a fifth embodiment, the invention concerns a method of producing an aquaculture meat product as described herein wherein the at least one transgenic microbe is cultured.

In a sixth embodiment, the invention concerns a method of producing an aquaculture meat product as described herein the biomass, processed biomass, partially purified oil and/or purified oil are obtained from the cultured transgenic microbe.

In a seventh embodiment, the invention concerns a method of producing an aquaculture meat product as described herein wherein the transgenic microbe is an oleaginous yeast. Preferably, the oleaginous yeast is Yarrowia lipolytica.

### DETAILED DESCRIPTION

All patents, patent applications, and publications cited herein are incorporated by reference in their entirety.

In this disclosure, a number of terms and abbreviations are used. The following definitions are provided.

“Polyunsaturated fatty acid(s)” is abbreviated as “PUFA(s)”.

“Triacylglycerols” are abbreviated as “TAGs”.

“Total fatty acids” are abbreviated as “TFAs”.

“Fatty acid methyl esters” are abbreviated as “FAMEs”.

“Dry cell weight” is abbreviated as “DCW”.

As used herein the term “invention” or “present invention” is intended to refer to all aspects and embodiments of the invention as described in the claims and specification herein and should not be read so as to be limited to any particular embodiment or aspect.

The indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The terms “aquaculture feed composition”, “aquaculture feed formulation”, “aquaculture feed” and “aquafeed” are used interchangeably herein. They refer to manufactured or artificial diets (i.e., formulated feeds) to supplement or to replace natural feeds in the aquaculture industry. These prepared foods are most commonly produced in flake, pellet or tablet form. Typically, an aquaculture feed composition refers to artificially compounded feeds that are useful for farmed finfish and crustaceans (i.e., both lower-value staple food fish species [e.g., freshwater finfish such as carp, tilapia and catfish] and higher-value cash crop species for luxury or niche markets [e.g., mainly marine and diadromous species such as shrimp, salmon, trout, yellowtail, seabass, seabream and grouper]). These formulated feeds are composed of ingredients in various proportions complementing each other to form a nutritionally complete diet for the aquacultured species.

An aquaculture feed composition is used in the production of an “aquaculture product”, wherein the product is a harvestable aquacultured species (e.g., finfish, crustaceans), which is often sold for human consumption. For example, salmon are intensively produced in aquaculture and, thus, are aquaculture products.

The term “aquaculture meat product” refers to food products intended for human consumption comprising at least a portion of meat from an aquaculture product as defined above. An aquaculture meat product may be, for example, a whole fish or a filet cut from a fish, each of which may be consumed as food.

“Eicosapentaenoic acid” [“EPA”] is the common name for cis-5,8,11,14,17-eicosapentaenoic acid. This fatty acid is a 20:5 omega-3 fatty acid. The term EPA as used in the present disclosure will refer to the acid or derivatives of the acid (e.g., glycerides, esters, phospholipids, amides, lactones, salts or the like) unless specifically mentioned otherwise.

“Docosahexaenoic acid” [“DHA”] is the common name for cis-4,7,10,13,16,19-docosahexaenoic acid. This fatty acid is a 22:6 omega-3 fatty acid. The term DHA as used in the present disclosure will refer to the acid or derivatives of the acid (e.g., glycerides, esters, phospholipids, amides, lactones, salts or the like) unless specifically mentioned otherwise.

As used herein the term “biomass” refers to microbial cellular material. Biomass may be produced naturally, or may be produced from the fermentation of a native host or a recombinant production host, such as one producing EPA. The biomass may be in the form of whole cells, whole cell lysates, homogenized cells, partially hydrolyzed cellular material, and/or partially purified cellular material (e.g., microbially produced oil). The term “processed biomass” refers to biomass that has been subjected to additional processing such as drying, pasterization, disruption, etc., each of which is discussed in greater detail below.

The term “oleaginous” refers to those organisms that tend to store their energy source in the form of lipid (Weete, In: Fungal Lipid Biochemistry, 2^{nd} Ed., Plenum, 1980). A class of plants identified as oleaginous are commonly referred to as “oilseed” plants. Examples of oilseed plants include, but are not limited to: soybean (Glycine and Soja sp.), flax (Linum sp.), rapeseed (Brassica sp.), maize, cotton, safflower (Carthamus sp.) and sunflower (Helianthus sp.).

Within oleaginous microorganisms the cellular oil or TAG content generally follows a sigmoid curve, wherein the concentration of lipid increases until it reaches a maximum at the late logarithmic or early stationary growth phase and then gradually decreases during the late stationary and death phases (Yongmanitchai and Ward, Appl. Environ. Microbiol. 57:419-25 (1991)).

The term “oleaginous yeast” refers to those microorganisms classified as yeasts that store their energy sources in the form of lipid. It is not uncommon for oleaginous microorganisms to accumulate in excess of about 25% of their dry cell weight as oil. Examples of oleaginous yeast include, but are no means limited to, the following genera: Yarrowia, Candida, Rhodotorula, Rhodosporidium, Cryptococcus, Trichosporon and Lipomyces.

The term “lipids” refer to any fat-soluble (i.e., lipophilic), naturally-occurring molecule. A general overview of lipids is provided in U.S. Pat. Appl. Pub. No. 2009-0093543-A1 (see Table 2 therein).

The term “oil” refers to a lipid substance that is liquid at 25° C. and usually polyunsaturated. In oleaginous organisms, oil constitutes a major part of the total lipid. “Oil” is composed primarily of triacylglycerols [“TAGs”] but may also contain other neutral lipids, phospholipids and free fatty acids. The fatty acid composition in the oil and the fatty acid composition of the total lipid are generally similar; thus, an increase or decrease in the concentration of PUFAs in the total lipid will correspond with an increase or decrease in the concentration of PUFAs in the oil, and vice versa.

The term “extracted oil” refers to an oil that has been separated from cellular materials, such as the microorganism in which the oil was synthesized. Extracted oils are obtained through a wide variety of methods, the simplest of which involves physical means alone. For example, mechanical crushing using various press configurations (e.g., screw, expeller, piston, bead beaters, etc.) can separate oil from cellular materials. Alternatively, oil extraction can occur via treatment with various organic solvents (e.g., hexane), via enzymatic extraction, via osmotic shock, via ultrasonic extraction, via supercritical fluid extraction (e.g., CO₂ extraction), via saponification and via combinations of these methods. An extracted oil may be further purified or concentrated.

“Fish oil” refers to oil derived from the tissues of an oily fish. Examples of oil fish include, but are not limited to: menhaden, anchovy, herring, capelin, cod and the like. Fish oil is a typical component of feed used in aquaculture.

“Menhaden” refer to forage fish of the genera Brevoortia and Ethmidium, two genera of marine fish in the family Clupeidae. Recent taxonomic work using DNA comparisons have organized the North American menhadens into large-scaled (Gulf and Atlantic menhaden) and small-scaled (Finescale and Yellowfin menhaden) designations (Anderson, J. D., Fishery Bulletin, 105(3):368-378).

“Anchovies” from which anchovy fish meal and anchovy fish oil are produced, are a family (Engraulidae) of small, common salt-water forage fish. There are about 140 species in 16 genera, found in the Atlantic, Indian, and Pacific Oceans.

“Vegetable oil” refers to any edible oil obtained from a plant. Typically plant oil is extracted from seed or grain of a plant.

The term “triacylglycerols” [“TAGs”] refers to neutral lipids composed of three fatty acyl residues esterified to a glycerol molecule. TAGs can contain long chain PUFAs and saturated fatty acids, as well as shorter chain saturated and unsaturated fatty acids.

“Neutral lipids” refer to those lipids commonly found in cells in lipid bodies as storage fats and are so called because at cellular pH, the lipids bear no charged groups. Generally, they are completely non-polar with no affinity for water. Neutral lipids generally refer to mono-, di-, and/or triesters of glycerol with fatty acids, also called monoacylglycerol, diacylglycerol or triacylglycerol, respectively, or collectively, acylglycerols. A hydrolysis reaction must occur to release free fatty acids from acylglycerols.

The term “total fatty acids” [“TFAs”] herein refers to the sum of all cellular fatty acids that can be derivitized to fatty acid methyl esters [“FAMEs”] by the base transesterification method (as known in the art) in a given sample, which may be biomass or oil, for example. Thus, total fatty acids include fatty acids from neutral lipid fractions (including diacylglycerols, monoacylglycerols and TAGs) and from polar lipid fractions (including, e.g., the phosphatidylcholine and phosphatidylethanolamine fractions) but not free fatty acids.

The term “total lipid content” of cells is a measure of TFAs as a percent of the dry cell weight [“DCW”], although total lipid content can be approximated as a measure of FAMEs as a percent of the DCW [“FAMEs % DCW”]. Thus, total lipid content [“TFAs % DCW”] is equivalent to, e.g., milligrams of total fatty acids per 100 milligrams of DCW.

The concentration of a fatty acid in the total lipid is expressed herein as a weight percent of TFAs (% TFAs), e.g., milligrams of the given fatty acid per 100 milligrams of TFAs. Unless otherwise specifically stated in the disclosure herein, reference to the percent of a given fatty acid with respect to total lipids is equivalent to concentration of the fatty acid as TFAs (e.g., % EPA of total lipids is equivalent to EPA % TFAs).

In some cases, it is useful to express the content of a given fatty acid(s) in a cell as its weight percent of the dry cell weight (% DCW). Thus, for example, eicosapentaenoic acid % DCW would be determined according to the following formula: (eicosapentaenoic acid % TFAs)*(TFAs % DCW)]/100. The content of a given fatty acid(s) in a cell as its weight percent of the dry cell weight (% DCW) can be approximated, however, as: (eicosapentaenoic acid % TFAs)*(FAMEs % DCW)]/100.

The terms “lipid profile” and “lipid composition” are interchangeable and refer to the amount of individual fatty acids contained in a particular lipid fraction, such as in the total lipid or the oil, wherein the amount is expressed as a weight percent of TFAs. The sum of each individual fatty acid present in the mixture should be 100.

The term “blended oil” refers to an oil that is obtained by admixing, or blending, the extracted oil described herein with any combination of, or individual, oil to obtain a desired composition. Thus, for example, types of oils from different microbes can be mixed together to obtain a desired PUFA composition. Alternatively, or additionally, the PUFA-containing oils disclosed herein can be blended with fish oil, vegetable oil or a mixture of both to obtain a desired composition.

The term “fatty acids” refers to long chain aliphatic acids (alkanoic acids) of varying chain lengths, from about C₁₂ to C₂₂, although both longer and shorter chain-length acids are known. The predominant chain lengths are between C₁₆ and C₂₂. The structure of a fatty acid is represented by a simple notation system of “X:Y”, where X is the total number of carbon [“C”] atoms in the particular fatty acid and Y is the number of double bonds. Additional details concerning the differentiation between “saturated fatty acids” versus “unsaturated fatty acids”, “monounsaturated fatty acids” versus “polyunsaturated fatty acids” [“PUFAs”], and “omega-6 fatty acids” [“ω-6” or “n-6”] versus “omega-3 fatty acids” [“ω-3” or “n-3”] are provided in U.S. Pat. No. 7,238,482, which is hereby incorporated herein by reference.

Nomenclature used to describe PUFAs herein is given in Table 1. In the column titled “Shorthand Notation”, the omega-reference system is used to indicate the number of carbons, the number of double bonds and the position of the double bond closest to the omega carbon, counting from the omega carbon, which is numbered 1 for this purpose. The remainder of the Table summarizes the common names of omega-3 and omega-6 fatty acids and their precursors, the abbreviations that will be used throughout the specification and the chemical name of each compound.

TABLE 1
Nomenclature of Polyunsaturated Fatty Acids And Precursors

| | | | Shorthand |
|---|---|---|---|
| Common Name | Abbreviation | Chemical Name | Notation |
| Myristic | — | tetradecanoic | 14:0 |
| Palmitic | Palmitate | hexadecanoic | 16:0 |
| Palmitoleic | — | 9-hexadecenoic | 16:1 |
| Stearic | — | octadecanoic | 18:0 |
| Oleic | — | cis-9-octadecenoic | 18:1 |
| Linoleic | LA | cis-9,12-octadecadienoic | 18:2 ω-6 |
| γ-Linolenic | GLA | cis-6,9,12-octadecatrienoic | 18:3 ω-6 |
| Eicosadienoic | EDA | cis-11,14-eicosadienoic | 20:2 ω-6 |
| Dihomo-γ- | DGLA | cis-8,11,14-eicosatrienoic | 20:3 ω-6 |
| Linolenic | | | |
| Arachidonic | ARA | cis-5,8,11,14- | 20:4 ω-6 |
| | | eicosatetraenoic | |
| α-Linolenic | ALA | cis-9,12,15- | 18:3 ω-3 |
| | | octadecatrienoic | |
| Stearidonic | STA | cis-6,9,12,15- | 18:4 ω-3 |
| | | octadecatetraenoic | |
| Eicosatrienoic | ETrA | cis-11,14,17-eicosatrienoic | 20:3 ω-3 |
| Eicosa- | ETA | cis-8,11,14,17- | 20:4 ω-3 |
| tetraenoic | | eicosatetraenoic | |
| Eicosa- | EPA | cis-5,8,11,14,17- | 20:5 ω-3 |
| pentaenoic | | eicosapentaenoic | |
| Docosa- | DTA | cis-7,10,13,16- | 22:4 ω-6 |
| tetraenoic | | docosatetraenoic | |
| Docosa- | DPAn-6 | cis-4,7,10,13,16- | 22:5 ω-6 |
| pentaenoic | | docosapentaenoic | |
| Docosa- | DPA | cis-7,10,13,16,19- | 22:5 ω-3 |
| pentaenoic | | docosapentaenoic | |
| Docosa- | DHA | cis-4,7,10,13,16,19- | 22:6 ω-3 |
| hexaenoic | | docosahexaenoic | |

As used herein, “transgenic” refers to any organism such as a microbe, plant, cell and the like which comprises within its genome at least one heterologous polynucleotide. Preferably, the at least one heterologous polynucleotide is stably integrated within the genome such that the at least one polynucleotide is passed on to successive generations. The at least one heterologous polynucleotide may be integrated into the genome alone or as part of an expression construct. Thus, transgenic is used herein to include any microbe, cell, cell line, and/or tissue, the genotype of which has been altered by the presence of at least one heterologous nucleic acid.

The term “transgenic microbe engineered for the production of PUFA-containing microbial oil comprising EPA” thus refers to a microbe which comprises within its genome at least one heterologous polynucleotide encoding an enzyme of an EPA biosynthetic pathway, wherein the EPA biosynthetic pathway refers to a metabolic process that converts oleic acid to EPA. Most commonly, the at least one heterologous polynucleotide encoding an enzyme of an EPA biosynthetic pathway will comprise at least one of the following genes: delta-5 desaturase, delta-6 desaturase, delta-12 desaturase, delta-15 desaturase, delta-17 desaturase, delta-9 desaturase, delta-8 desaturase, delta-9 elongase, C_{14/16} elongase, C_{16/18} elongase, and/or C_{18/20} elongase.

“Fish meal” refers to a protein source for aquaculture feed compositions. Fish meals are typically either produced from fishery wastes associated with the processing of fish for human consumption (e.g., salmon, tuna) or produced from specific fish (i.e., herring, menhaden, pollack) which are harvested solely for the purpose of producing fish meal.

Aquaculture is the practice of farming aquatic animals and plants. It involves cultivating an aquatic product (e.g., freshwater and saltwater animals) under controlled conditions. It involves growing and harvesting fish, shellfish, and aquatic plants in fresh, brackish or salt water.

Organisms grown in aquaculture may include fish and crustaceans. Crustaceans are, for example, lobsters, crabs, shrimp, prawns and crayfish. The farming of finfish is the most common form of aquaculture. It involves raising fish commercially in tanks, ponds, or ocean enclosures, usually for food. A facility that releases juvenile fish into the wild for recreational fishing or to supplement a species' natural numbers is generally referred to as a fish hatchery. Particularly of interest are fish of the salmonid group, for example, cherry salmon (Oncorhynchus masou), Chinook salmon (O. tshawytscha), chum salmon (O. keta), coho salmon (O. kisutch), pink salmon (O. gorbuscha), sockeye salmon (O. nerka) and Atlantic salmon (Salmo salar). Other finfish of interest for aquaculture include, but are not limited to, various trout, as well as whitefish such as tilapia (including various species of Oreochromis, Sarotherodon, and Tilapia), grouper (subfamily Epinephelinae), sea bass, catfish (order Siluriformes), bigeye tuna (Thunnus obesus), carp (family Cyprinidae) and cod (genus Gadus).

Aquaculture typically requires a prepared aquaculture feed composition to meet dietary requirements of the cultured animals. Dietary requirements of different aquaculture species vary, as do the dietary requirements of a single species during different stages of growth. Thus, tremendous research is invested towards optimizing each aquaculture feed composition for each stage of growth of a cultured organism.

As an example, one can consider the 6-phase life cycle of Alaskan salmon. In the wild, the salmon life cycle begins with the fertilization of spawned eggs. The eggs hatch into “alevin”, which live off the nutritious yolk sac that hangs off their undersides for several months. Then, alevin develop into “fry”, which feed mainly on zooplankton until they grow large enough to eat aquatic insects and other larger foods. When the fry are several months to 1 year old, they develop very noticeable markings along their flanks. They are then termed salmon “parr”, which feed mainly on freshwater terrestrial and aquatic insects, amphipods, worms, crustaceans, amphibian larvae, fish eggs, and young fish for 1 to 3 years. The process of smolting, which normally occurs when the fish are 12-18 months old, enables the “smolts” to transition from a freshwater environment to open salt water seas. Adult salmon feed on smaller fish, such as herring, sandeels, pelagic amphipods and krill while in the open ocean; they will return to the rivers in which they were born after being at sea for 1-4 yr.

In aquaculture, salmon are typically farmed in two stages. In the first stage, fish are hatched from eggs and raised in freshwater tanks for 12-18 months to the smolt stage. Alternatively, spawning channels, or artificial streams, may be used in the first stage. In the second stage, the smolt are transferred to floating sea cages or net pens which are anchored in bays or fjords along a coast. Cages or pens are provided with feed delivery equipment. Aquacultured animals may be fed different aquaculture feed compositions over time, that are formulated to meet the changing nutrient requirements needed during different stages of growth (Handbook of Salmon Farming; Stead and Laird (eds) (2002) Praxis Publishing Ltd., Chichester, UK). In the present method, aquaculture animals may be fed the present aquaculture feed compositions to support their growth by any method of aquaculture known by one skilled in the art (“Food for Thought: the Use of Marine Resources in Fish Feed”, Editor: Tveferaas, Head Of Conservation, WWF-Norway, Report #02/03 (February 2003)).

Once the aquaculture animals reach an appropriate size, the crop is harvested, processed to meet consumer requirements, and can be shipped to market, generally arriving within hours of leaving the water. For example, a common harvesting method for fish is to use a sweep net, which operates a bit like a purse seine net. The sweep net is a big net with weights along the bottom edge. It is stretched across the pen with the bottom edge extending to the bottom of the pen. Lines attached to the bottom corners are raised, herding some fish into the purse, where they are netted. More advanced systems use a percussive-stun harvest system that kills the fish instantly and humanely with a blow to the head from a pneumatic piston. They are then bled by cutting the gill arches and immediately immersed in iced water. Harvesting and killing methods are designed to minimize scale loss, and avoid the fish releasing stress hormones, which negatively affect flesh quality.

To produce a salmon of harvestable size (i.e., 2.5-4 kg), appropriate aquaculture feed compositions may be formulated as appropriate over the dietary cycles of the salmon. Commercial feeds generally rely on available supplies of fish oil to provide energy and specific fatty acid requirements for aquacultured fish. Generally, it takes between 3 and 7 kg, with the average of around 5 kg, of captured pelagic fish to provide the fish oil necessary to produce one kg of salmon. Thus, the limited global supply of fish oil will ultimately limit growth of aquaculture industries. Additionally, removal of large numbers of smaller species of fish from the food chain can have adverse ecosystem affects.

Aquaculture feed compositions are composed of micro and macro components. In general, all components, which are used at levels of more than 1%, are considered as macro components. Feed ingredients used at levels of less than 1% are micro components. They are premixed to achieve a homogeneous distribution of the micro components in the complete feed. Both macro and micro ingredients are subdivided into components with nutritional functions and technical functions. Components with technical functions improve the physical quality of the aquaculture feed composition or its appearance.

Macro components with nutritional functions provide aquatic animals with protein and energy required for growth and performance. With respect to fish, the aquaculture feed composition should ideally provide the fish with: 1) fats, which serve as a source of fatty acids for energy (especially for heart and skeletal muscles); and, 2) amino acids, which serve as building blocks of proteins. Fats also assist in vitamin absorption; for example, vitamins A, D, E and K are fat-soluble or can only be digested, absorbed, and transported in conjunction with fats. Carbohydrates, typically of plant origin (e.g., wheat, sunflower meal, corn gluten, soybean meal), are also often included in the feed compositions, although carbohydrates are not a superior energy source for fish over protein or fat.

Fats are typically provided via incorporation of fish meals (which contain a minor amount of fish oil) and fish oils into the aquaculture feed compositions. Extracted oils that may be used in aquaculture feed compositions include fish oils (e.g., from the oily fish menhaden, anchovy, herring, capelin and cod liver), and vegetable oil (e.g., from soybeans, rapeseeds, sunflower seeds and flax seeds). Typically, fish oil is the preferred oil, because it contains the long chain omega-3 polyunsaturated fatty acids [“PUFAs”], EPA and DHA; in contrast, vegetable oils do not provide a source of EPA and/or DHA. These PUFAs are needed for growth and health of most aquaculture products. A typical aquaculture feed composition will comprise from about 15-30% of oil (e.g., fish, vegetable, etc.), measured as a weight percent of the aquaculture feed composition.

The amount of EPA (as a percent of total fatty acids [“% TFAs”]) and DHA % TFAs provided in typical fish oils varies, as does the ratio of EPA to DHA. Typical values are summarized in Table 2, based on the work of Turchini, Torstensen and Ng (Reviews in Aquaculture 1:10-57 (2009)):

TABLE 2
Typical EPA And DHA Content In Various Fish Oils

| Fish Oil | EPA | DHA | EPA:DHA Ratio |
|---|---|---|---|
| Anchovy oil | 17% | 8.8% | 1.93 |
| Capelin oil | 4.6% | 3.0% | 1.53 |
| Menhaden oil | 11% | 9.1% | 1.21 |
| Herring oil | 8.4% | 4.9% | 1.71 |
| Cod liver oil | 11.2% | 12.6% | 0.89 |

Often, oil from fish that have lower EPA:DHA ratios is used in aquaculture feed compositions, due to the lower cost. Anchovy oil has the highest EPA:DHA ratio; however, using this oil as the sole oil source in an aquaculture feed composition would result in an EPA:DHA ratio of less than 2:1 in the final formulation.

The protein supplied in aquaculture feed compositions can be of plant or animal origin. For example, protein of animal origin can be from marine animals (e.g., fish meal, fish oil, fish protein, krill meal, mussel meal, shrimp peel, squid meal, squid oil, etc.) or land animals (e.g., blood meal, egg powder, liver meal, meat meal, meat and bone meal, silkworm, pupae meal, whey powder, etc.). Protein of plant origin can include soybean meal, corn gluten meal, wheat gluten, cottonseed meal, canola meal, sunflower meal, rice and the like.

The technical functions of macro components can be overlapping as, for example, wheat gluten may be used as a pelleting aid and for its protein content, which has a relatively high nutritional value. There can be mentioned guar gum and wheat flour.

Micro components include feed additives such as vitamins, trace minerals, feed antibiotics and other biologicals. Minerals used at levels of less than 100 mg/kg (100 ppm) are considered as micro minerals or trace minerals.

Micro components with nutritional functions are all biologicals and trace minerals. They are involved in biological processes and are needed for good health and high performance. There can be mentioned vitamins such as vitamins A, E, K₃, D₃, B₁, B₃, B₆, B₁₂, C, biotin, folic acid, panthothenic acid, nicotinic acid, choline chloride, inositiol and para-amino-benzoic acid. There can be mentioned minerals such as salts of calcium, cobalt, copper, iron, magnesium, phosophorus, potassium, selenium and zinc. Other components may include, but are not limited to, antioxidants, beta-glucans, bile salt, cholesterol, enzymes, monosodium glutamate, carotenoids, etc.

The technical functions of micro ingredients are mainly related to pelleting, detoxifying, mold prevention, antioxidation, etc.

The present invention concerns aquaculture meat products that contain EPA and DHA in a ratio that is equal to or greater than 1.4 to 1 (i.e., 1.4:1), based on the concentration of each of EPA and DHA in the aquaculture meat product. The ratio of concentration of each of EPA to DHA may be equal to or greater than 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1, 3:1, 3.5:1, 4:1, 4.5:1, 5:1, 5.5:1, 6:1, 6.5:1, 7:1, 7.5:1, 8:1, 8.5:1, 9:1, 9.5:1, or 10:1 or higher. Although preferred EPA:DHA ratios are described above, useful examples of EPA:DHA ratios include any integer or portion thereof that is equal to or greater than 1.4:1. These ratios are greater than the EPA:DHA ratios found in aquaculture meat products obtained from commercial fish, including wild and aquaculture raised fish. The EPA:DHA ratios found in commercially obtained aquaculture meat products is typically between 0.25:1 and 1.25:1, as determined by an extensive analysis of the EPA and DHA contents of commercial fish, as set forth in Example 1 herein below. Thus, it is believed that no commercially available aquaculture meat product has been produced having an EPA:DHA ratio equal to or greater than 1.4:1 based on the concentration of each of EPA and DHA in the aquaculture meat product, prior to the invention as disclosed herein.

The aquaculture meat product of the invention may further comprise a total amount of EPA and DHA that is at least about 0.5% as a weight percent of the aquaculture meat product. This amount is an amount that typically is present in aquaculture meat products, as exemplified in the commercial fish analysis of Example 1 herein.

Commercially available aquaculture feeds containing fish oil cannot be used to produce the aquaculture meat products of the invention.

Accordingly, the present invention further concerns a method of producing an aquaculture meat product comprising:
a) providing an aquaculture feed comprising at least one source of EPA and, optionally, at least one source of DHA wherein said source can be the same or different;
b) feeding the aquaculture feed of (a) to fish; and,
c) harvesting an aquaculture meat product from the fish of (b);
   wherein the ratio of EPA to DHA in the aquaculture meat product of (c) is equal to or greater than 1.4 to 1 based on the individual concentrations of EPA and DHA in the aquaculture meat product.

Most processes to make an aquaculture meat product of the invention will begin with a microbial fermentation, wherein a particular microorganism is cultured under conditions that permit growth and production of microbial oils comprising EPA and/or DHA. At an appropriate time, the microbial cells are harvested from the fermentation vessel. This microbial biomass may be mechanically processed using various means, such as dewatering, drying, mechanical disruption, pelletization, etc. Then, the biomass (or extracted oil therefrom) is used as an ingredient in an aquaculture feed (preferably as a substitute for at least a portion of the fish oil used in standard aquaculture feed compositions), such that the resulting aquaculture feed typically has an EPA:DHA ratio of at least about 4:1. The aquaculture feed is then fed to aquatic animals over a portion of their lifetime, such that EPA and DHA from the aquaculture feed accumulate in the aquatic animals. Upon harvesting, the resulting aquaculture meat product will thereby comprise a ratio of EPA:DHA that is equal to or greater than 1.4 to 1. Each of these aspects will be discussed in further detail below.

In preferred embodiments of the present method, the aquaculture meat product is produced by feeding aquatic animals, such as fish, aquaculture feed compositions comprising microbial oil comprising EPA (and, optionally, DHA). Microbial oil may be from multiple microbes, for example, microbes having a natural ability to produce EPA (and, optionally, DHA), from multiple strains of engineered Yarrowia as described below, from strains of different recombinantly engineered yeasts, from strains of different recombinantly engineered microalgae, from a recombinantly engineered Yarrowia strain and a recombinantly engineered microalgae strain or from combinations thereof.

The microbial oil may optionally be included in aquaculture feed in combination with fish oil as an additional source of fatty acids, which may be added as a component of fish meal, and/or as fish oil itself. By including microbial oil as a source of EPA (and, optionally, DHA), the total amount of fish oil that is required in the feed formulation to maintain the desired EPA (and, optionally, DHA) content is reduced. In some formulations, the microbial oil comprising EPA (and, optionally, DHA) may be supplemented with a vegetable oil, to reach the desired total oil/fat content.

EPA can be produced microbially via numerous different processes, based on the natural abilities of the specific microbial organism utilized [e.g., heterotrophic diatoms Cyclotella sp. and Nitzschia sp. (U.S. Pat. No. 5,244,921); Pseudomonas, Alteromonas or Shewanella species (U.S. Pat. No. 5,246,841); filamentous fungi of the genus Pythium (U.S. Pat. No. 5,246,842); or Mortierella elongata, M. exigua, or M. hygrophila (U.S. Pat. No. 5,401,646)]. One of skill in the art will be able to identity other microbes having the native ability to produce EPA, based on phenotypic analysis, GC analysis of the PUFA products, review of available public and patent literature and screening of microbes related to those previously identified as EPA-producers. Microbial oils comprising EPA from these organisms may be provided in a variety of forms for use in aquaculture feed compositions used to produce the aquaculture meat products herein, wherein the oil is typically contained within microbial biomass or processed biomass, or the oil is partially purified or purified oil. In most cases, it will be most cost effective to incorporate microbial biomass or processed biomass into the aquaculture feed composition, as opposed to the microbial oil (in partial or purified form); however, these economics should not be considered as a limitation herein.

DHA can be produced using processes based on the natural abilities of native microbes. See, e.g., processes developed for Schizochytrium species (U.S. Pat. No. 5,340,742; U.S. Pat. No. 6,582,941); Ulkenia (U.S. Pat. No. 6,509,178); Pseudomonas sp. YS-180 (U.S. Pat. No. 6,207,441); Thraustochytrium genus strain LFF1 (U.S. Pat. No. 7,259,006); Crypthecodinium cohnii (U.S. Pat. No. 7,674,609; de Swaaf, M. E. et al. Biotechnol Bioeng., 81(6):666-72 (2003) and Appl Microbiol Biotechnol., 61(1):40-3 (2003)); Emiliania sp. (Japanese Patent Publication (Kokai) No. 5-308978 (1993)); and Japonochytrium sp. (ATCC #28207; Japanese Patent Publication (Kokai) No. 199588/1989)]. Additionally, the following microorganisms are known to have the ability to produce DHA: Vibrio marinus (a bacterium isolated from the deep sea; ATCC #15381); the micro-algae Cyclotella cryptica and Isochrysis galbana; and, flagellate fungi such as Thraustochytrium aureum (ATCC #34304; Kendrick, Lipids, 27:15 (1992)) and the Thraustochytrium sp. designated as ATCC #28211, ATCC #20890 and ATCC #20891. Currently, there are at least three different fermentation processes for commercial production of DHA: fermentation of C. cohnii for production of DHASCO™ (Martek Biosciences Corporation, Columbia, Md.); fermentation of Schizochytrium sp. for production of an oil formerly known as DHAGold (Martek Biosciences Corporation); and fermentation of Ulkenia sp. for production of DHActive™ (Nutrinova, Frankfurt, Germany). As such, microbial oils comprising DHA from any of these organisms may be provided in a variety of forms for use in the aquaculture feed compositions herein, wherein the oil is typically contained within microbial biomass or processed biomass, or the oil is partially purified or purified oil.

Alternately, microbial oil comprising EPA and/or DHA can be produced in transgenic microbes recombinantly engineered for the production of PUFA-containing microbial oil comprising EPA and/or DHA. Microbes such as algae, fungi, yeast, stramenopiles and bacteria may be engineered for production of PUFAs by expressing appropriate heterologous genes encoding desaturases and elongases of either the delta-6 desaturase/delta-6 elongase pathway or the delta-9 elongase/delta-8 desaturase pathway in the host organism. Only two additional enzymatic steps are required to convert EPA to DHA and thus expression of appropriate heterologous genes encoding C_{20/22} elongase and delta-4 desaturase will be readily possible, upon obtaining an organism capable of EPA production.

Heterologous genes in expression cassettes are typically integrated into the host cell genome. The particular gene(s) included within a particular expression cassette depend on the host organism, its PUFA profile and/or desaturase/elongase profile, the availability of substrate and the desired end product(s).

A PUFA polyketide synthase [“PKS”] system that produces EPA, such as that found in e.g., Shewanella putrefaciens (U.S. Pat. No. 6,140,486), Shewanella olleyana (U.S. Pat. No. 7,217,856), Shewanella japonica (U.S. Pat. No. 7,217,856) and Vibrio marinus (U.S. Pat. No. 6,140,486), could also be introduced into a suitable microbe to enable EPA, and optionally DHA, production. Host organisms with other PKS systems that natively produce DHA could also be engineered to enable production of only EPA or a suitable combination of the EPA and DHA to use in aquaculture feed to produce the present aquaculture meat product.

One skilled in the art is familiar with the considerations and techniques necessary to introduce one or more expression cassettes encoding appropriate enzymes for EPA and/or DHA biosynthesis into a microbial host organism of choice, and numerous teachings are provided in the literature to one of skill. Microbial oils comprising EPA and/or DHA from these genetically engineered organisms may also be suitable for use in the aquaculture feed compositions herein, wherein the oil may be contained within the microbial biomass or processed biomass, or the oil may be partially purified or purified oil.

In some applications, the microbe engineered for EPA and/or DHA production is oleaginous, i.e., the organism tends to store its energy source in the form of lipid (Weete, In: Fungal Lipid Biochemistry, 2^{nd} Ed., Plenum, 1980). Oleaginous yeast are a preferred microbe, as these microorganisms can commonly accumulate in excess of about 25% of their dry cell weight as oil. Examples of oleaginous yeast include, but are by no means limited to, the following genera: Yarrowia, Candida, Rhodotorula, Rhodosporidium, Cryptococcus, Trichosporon and Lipomyces. More specifically, illustrative oil-synthesizing yeasts include: Rhodosporidium toruloides, Lipomyces starkeyii, L. lipoferus, Candida revkaufi, C. pulcherrima, C. tropicalis, C. utilis, Trichosporon pullans, T. cutaneum, Rhodotorula glutinus, R. graminis, and Yarrowia lipolytica (formerly classified as Candida lipolytica). Most preferred is the oleaginous yeast Yarrowia lipolytica. Examples of suitable Y. lipolytica strains include, but are not limited to Y. lipolytica strains designated as ATCC #20362, ATCC #8862, ATCC #18944, ATCC #76982 and/or LGAM S(7)1 (Papanikolaou S., and Aggelis G., Bioresour. Technol. 82(1):43-9 (2002)).

Some references describing means to engineer the oleaginous host organism Yarrowia lipolytica for EPA and/or DHA biosynthesis are provided as follows: U.S. Pat. No. 7,238,482, U.S. Pat. No. 7,550,286, U.S. Pat. No. 7,932,077, U.S. Pat. Appl. Pub. No. 2009-0093543-A1, U.S. Pat. Appl. Pub. No. 2010-0317072-A1 and U.S. Pat. Appl. Pub. No. 2010-0317735-A1. This list is not exhaustive and should not be construed as limiting.

It may be desirable for the oleaginous yeast to be capable of “high-level EPA production”, wherein the organism can produce at least about 5-10% of EPA in the total lipids. More preferably, the oleaginous yeast will produce at least about 10-25% of EPA in the total lipids, more preferably at least about 25-35% of EPA in the total lipids, more preferably at least about 35-45% of EPA in the total lipids, more preferably at least about 45-55% of EPA in the total lipids, and most preferably at least about 55-60% of EPA in the total lipids. The structural form of the EPA is not limiting; thus, for example, EPA may exist in the total lipids as free fatty acids or in esterified forms such as acylglycerols, phospholipids, sulfolipids or glycolipids

For example, U.S. Pat. Appl. Pub. No. 2009-0093543-A1 describes high-level EPA production in optimized recombinant Yarrowia lipolytica strains. Specifically, strains are disclosed having the ability to produce microbial oils comprising at least about 43.3 EPA % TFAs, with less than about 23.6 LA % TFAs (an EPA:LA ratio of 1.83) and less than about 9.4 oleic acid (18:1) % TFAs. The preferred strain was Y4305, whose maximum production was 55.6 EPA % TFAs, with an EPA:LA ratio of 3.03. Generally, the EPA producing strains of U.S. Pat. Appl. Pub. No. 2009-0093543-A1 comprised the following genes of the omega-3/omega-6 fatty acid biosynthetic pathway: a) at least one gene encoding delta-9 elongase; b) at least one gene encoding delta-8 desaturase; c) at least one gene encoding delta-5 desaturase; d) at least one gene encoding delta-17 desaturase; e) at least one gene encoding delta-12 desaturase; f) at least one gene encoding C_{16/18} elongase; and, g) optionally, at least one gene encoding diacylglycerol cholinephosphotransferase [“CPT1”]. Since the pathway is genetically engineered into the host cell, there is no DHA concomitantly produced due to the lack of the appropriate enzymatic activities for elongation of EPA to DPA (catalyzed by a C_{20/22} elongase) and desaturation of DPA to DHA (catalyzed by a delta-4 desaturase). The disclosure also describes microbial oils obtained from these engineered yeast strains and oil concentrates thereof.

A derivative of Yarrowia lipolytica strain Y4305 is described herein, known as Y. lipolytica strain Y4305 F1B1. Upon growth in a two liter fermentation (parameters similar to those of U.S. Pat. Appl. Pub. No. 2009-009354-A1, Example 10), average EPA productivity [“EPA % DCW”] for strain Y4305 was 50-56, as compared to 50-52 for strain Y4305-F1B1. Average lipid content [“TFAs % DCW”] for strain Y4305 was 20-25, as compared to 28-32 for strain Y4305-F1B1. Thus, lipid content was increased 29-38% in strain Y4503-F1B1, with minimal impact upon EPA productivity.

More recently, U.S. Pat. Appl. Pub. No. 2010-0317072-A1 and U.S. Pat. Appl. Pub. No. 2010-0317735-A1 teach optimized strains of recombinant Yarrowia lipolytica having the ability to produce further improved microbial oils relative to those strains described in U.S. Pat. Appl. Pub. No. 2009-0093543-A1, based on the EPA % TFAs and the ratio of EPA:LA. In addition to expressing genes of the omega-3/omega-6 fatty acid biosynthetic pathway as detailed in U.S. Pat. Appl. Pub. No. 2009-0093543-A1, these improved strains are distinguished by: a) comprising at least one multizyme, wherein said multizyme comprises a polypeptide having at least one fatty acid delta-9 elongase linked to at least one fatty acid delta-8 desaturase [a “DGLA synthase”]; b) optionally comprising at least one polynucleotide encoding an enzyme selected from the group consisting of a malonyl CoA synthetase or an acyl-CoA lysophospholipid acyltransferase [“LPLAT”]; c) comprising at least one peroxisome biogenesis factor protein whose expression has been down-regulated; d) producing at least about 50 EPA % TFAs; and, e) having a ratio of EPA:LA of at least about 3.1.

Specifically, in addition to possessing at least about 50 EPA TFAs, the lipid profile within the improved optimized strains of Yarrrowia lipolytica of U.S. Pat. Appl. Pub. No. 2010-0317072-A1 and U.S. Pat. Appl. Pub. No. 2010-0317735-A1, or within extracted or unconcentrated oil therefrom, will have a ratio of EPA % TFAs to LA % TFAs of at least about 3.1. Lipids produced by the improved optimized recombinant Y. lipolytica strains are also distinguished as having less than 0.5% GLA or DHA (when measured by GC analysis using equipment having a detectable level down to about 0.1%) and having a saturated fatty acid content of less than about 8%. This low percent of saturated fatty acids (i.e., 16:0 and 18:0) benefits both humans and animals.

Thus, it is considered that the EPA containing oils described above from genetically engineered strains of Yarrowia lipolytica are substantially free of DHA, low in saturated fatty acids and high in EPA. Example 5 herein provides a summary of some representative strains of Yarrowia lipolytica engineered to produce high levels of EPA. Furthermore, the cited art provides numerous examples of additional suitable microbial strains and species, comprising EPA and having an EPA:DHA ratio of greater than 2:1.

To obtain an EPA:DHA ratio of 1.4:1 or greater in an aquaculture meat product, the ratio of EPA:DHA in the aquaculture feed composition that is fed to the aquaculture animals that are the source of the meat product is typically at least about 4:1.” So you need much at least 4:1 in the biomass and really higher because of the DHA in the fish meal. It is also contemplated herein that any of the EPA producing microbes provided herein or known in the art could be subjected to further genetic engineering improvements and thus be suitable sources of EPA for the methods described herein.

When a microbe (or combination of microbes) is used in the present invention as a source of EPA (and optionally DHA), the microbe will be grown under standard conditions well known by one skilled in the art of microbiology or fermentation science to optimize the production of the desired PUFA(s). With respect to genetically engineered microbes, the microbe will be grown under conditions that optimize expression of chimeric genes (e.g., encoding desaturases, elongases, acyltransferases, etc.) and produce the greatest and the most economical yield of the desired PUFA(s). Thus, for example, a genetically engineered microbe producing lipids containing EPA may be cultured and grown in a fermentation medium under conditions whereby EPA is produced by the microorganism. Typically, the microorganism is fed with a carbon and nitrogen source, along with a number of additional chemicals or substances that allow growth of the microorganism and/or production of EPA and/or DHA. The fermentation conditions will depend on the microorganism used and may be optimized for a high content of the desired PUFA(s) in the resulting biomass.

In general, media conditions may be optimized by modifying the type and amount of carbon source, the type and amount of nitrogen source, the carbon-to-nitrogen ratio, the amount of different mineral ions, the oxygen level, growth temperature, pH, length of the biomass production phase, length of the oil accumulation phase and the time and method of cell harvest.

More specifically, fermentation media should contain a suitable carbon source, such as are taught in U.S. Pat. No. 7,238,482 and U.S. Pat. Pub. No. 2011-0059204-A1. Although it is contemplated that the source of carbon utilized for growth of an engineered PUFA-producing microbe may encompass a wide variety of carbon-containing sources, preferred carbon sources are sugars, glycerol and/or fatty acids. Most preferred are glucose, sucrose, invert sucrose, fructose and/or fatty acids containing between 10-22 carbons. For example, the fermentable carbon source can be selected from the group consisting of invert sucrose (i.e., a mixture comprising equal parts of fructose and glucose resulting from the hydrolysis of sucrose), glucose, fructose and combinations of these, provided that glucose is used in combination with invert sucrose and/or fructose.

Nitrogen may be supplied from an inorganic (e.g., (NH₄)₂SO₄) or organic (e.g., urea or glutamate) source. In addition to appropriate carbon and nitrogen sources, the fermentation media also contains suitable minerals, salts, cofactors, buffers, vitamins and other components known to those skilled in the art suitable for the growth of the oleaginous yeast and promotion of the enzymatic pathways necessary for PUFA production. Particular attention is given to several metal ions (e.g., Fe⁺², Cu⁺², Mn⁺², Co⁺², Zn⁺² and Mg⁺²) that promote synthesis of lipids and PUFAs (Nakahara, T. et al., Ind. Appl. Single Cell Oils, D. J. Kyle and R. Colin, eds. pp 61-97 (1992)).

Preferred growth media are common commercially prepared media, such as Yeast Nitrogen Base (DIFCO Laboratories, Detroit, Mich.). Other defined or synthetic growth media may also be used and the appropriate medium for growth of oleaginous yeast such as Yarrowia lipolytica will be known by one skilled in the art of microbiology or fermentation science. A suitable pH range for the fermentation is typically between about pH 4.0 to pH 8.0, wherein pH 5.5 to pH 7.5 is preferred as the range for the initial growth conditions. The fermentation may be conducted under aerobic or anaerobic conditions.

Typically, accumulation of high levels of PUFAs in oleaginous yeast cells requires a two-stage process, since the metabolic state must be “balanced” between growth and synthesis/storage of fats. Thus, most preferably, a two-stage fermentation process is necessary for the production of PUFAs in Yarrowia lipolytica. This approach is described in U.S. Pat. No. 7,238,482, as are various suitable fermentation process designs (i.e., batch, fed-batch and continuous) and considerations during growth.

When the desired amount of EPA and/or DHA has been produced by the microorganism(s), the fermentation medium may be treated to obtain microbial biomass comprising the PUFA(s). For example, the fermentation medium may be filtered or otherwise treated to remove at least part of the aqueous component. The fermentation medium and/or the microbial biomass may be further processed, for example the microbial biomass may be pasteurized or treated via other means to reduce the activity of endogenous microbial enzymes that can harm the microbial oil and/or PUFAs. The microbial biomass may be subjected to drying (e.g., to a desired water content) or a means of mechanical disruption (e.g., via physical means such as bead beaters, screw extrusion, etc. to provide greater accessibility to the cell contents), or a combination of these. The microbial biomass may be granulated or pelletized for ease of handling. A brief review of downstream processing is also available by A. Singh and O. Ward (Adv. Appl. Microbiol., 45:271-312 (1997)).

Thus, microbial biomass obtained by any of the means described above may be used as a source of microbial oil comprising EPA, as a source of microbial oil comprising DHA, or as a source of microbial oil comprising EPA and DHA. This source of microbial oil may then be used as an ingredient in the aquaculture feed compositions described herein, which are then fed to aquatic animals to produce the present aquaculture meat products.

In some embodiments, the PUFAs may be extracted from the host cell through a variety of means well-known in the art. This may be useful, since PUFAs, including EPA and DHA, may be found in the host microorganism as free fatty acids or in esterified forms such as acylglycerols, phospholipids, sulfolipids or glycolipids. One review of extraction techniques, quality analysis and acceptability standards for yeast lipids is that of Z. Jacobs (Critical Reviews in Biotechnology, 12(5/6):463-491 (1992)). In general, extraction may be performed with organic solvents, sonication, supercritical fluid extraction (e.g., using carbon dioxide), saponification and physical means such as presses, extrusion, or combinations thereof. One is referred to the teachings of U.S. Pat. No. 7,238,482 for additional details.

Thus, microbial oil, whether partially purified, purified, or present as a component of biomass or processed biomass, obtained from any of the means described above may be used as a source of EPA and/or DHA for use in aquaculture feed compositions that are fed to aquaculture animals to produce the present aquaculture meat products. Preferably, the microbial oil will be used as a replacement of at least a portion of the fish oil that would be used in a similar aquaculture feed composition.

The amount of EPA and/or DHA in an aquaculture feed composition may be calculated from the components containing EPA and/or DHA which are in the aquaculture feed formulation. The appropriate amount of microbial oil comprising EPA (and optionally, DHA) to be included in an aquaculture feed composition that is used to feed aquaculture animals to produce the present aquaculture meat products will vary depending on factors such as the EPA % TFAs (and optionally, DHA % TFAs) in the microbial oil, and the content of EPA and DHA in other components to be added to the aquaculture feed composition (e.g., fishmeal, fish oil, vegetable oil, microalgae oil).

Typically, however, the predominant source of EPA in the feed composition will be from the microbial oil comprising EPA, while DHA is introduced into aquaculture feed compositions from sources such as fish oils within fish meal, from fish oil added directly to the aquaculture feed composition itself, and/or from microbial oil comprising DHA (where the source of microbial oil used to supply EPA may be the same or different from the source of microbial oil used to supply DHA).

To obtain an EPA:DHA ratio of 1.4:1 or greater in an aquaculture meat product, the ratio of EPA:DHA in the aquaculture feed composition that is fed to the aquaculture animals that are the source of the meat product is typically at least about 4:1. This ratio may be extrapolated from data obtained in Example 3 herein where Diet 1 containing EPA and DHA in a ratio of 3.1:1 produced an aquaculture meat product with an EPA:DHA ratio of 1.1:1. Diet 2 containing an EPA:DHA ratio of an average of 9.2:1 produced an aquaculture meat product with an EPA:DHA ratio well above 1.4:1. The ratio of EPA:DHA in the aquaculture feed used to produce a meat product having an EPA:DHA ratio of 1.4:1 or greater may vary depending on additional oil components and other components of the aquaculture feed.

Thus, one of skill in the art may readily calculate the amount of DHA present in components to be added to aquaculture feed compositions, and then determine the amount of EPA needed to provide a ratio of EPA:DHA in the aquaculture feed composition that will support production of a meat product having an EPA:DHA ratio of at least 1.4:1.

Exemplary calculations of EPA content, DHA content and EPA:DHA ratios in aquaculture feed compositions are provided in Example 4 herein, based on formulations with variable concentrations (i.e., 10%, 20% and 30%) of Yarrowia lipolytica Y4305 F1B1 biomass, which was assumed to contain 15 EPA % DCW, 50 EPA % TFAs and 0.0 DHA % TFAs. More specifically, various calculations are provided to demonstrate how this microbial biomass containing EPA could readily be mixed with variable concentrations of either anchovy oil or menhaden oil (0%, 2%, 5%, 10% and 20%) to result in aquaculture feed compositions comprising from 1.8% to 10.02% total EPA and DHA in the final composition, with EPA:DHA ratios ranging from 1.94:1 up to 47.7:1.

For example, if an aquaculture feed composition is prepared comprising anchovy fishmeal (25% of total weight), anchovy oil at 5% of total weight, and Yarrowia lipolytica Y4305 F1B1 biomass that provides 15 EPA % DCW (10% of total weight), the EPA:DHA ratio is calculated to be 4.75:1. With less anchovy oil and/or more Y. lipolytica Y4305 F1B1 biomass, the EPA:DHA ratio increases. In another example, if an aquaculture feed composition is prepared comprising menhaden fishmeal (25% of total weight), menhaden oil at 2% of total weight, and with Yarrowia lipolytica Y4305 F1B1 biomass that provides 15 EPA % DCW (10% of total weight), EPA:DHA ratio is calculated to be 6.1:1. If fish oil is not used in the aquaculture feed composition, as seen in the scenarios using no anchovy oil or menhaden oil, then DHA will be available in the final composition only as a result of fishmeal; this leads to even higher EPA:DHA ratios.

Aquaculture meat products obtained using the methods of the invention may further comprise a total amount of EPA and DHA that is at least about 0.5% as a weight percent of the aquaculture meat product. This amount is an amount that typically is present in aquaculture meat products, as exemplified in the commercial fish analysis of Example 1 herein.

A total amount of EPA and DHA that is at least about 0.5% as weight percent of an aquaculture meat product may be obtained by feeding aquaculture animals with an aquaculture feed composition having a sum of EPA plus DHA that is typically at least about 1.6% of the aquaculture feed composition by weight. Examples of calculations based on the sum of EPA plus DHA in aquaculture feed compositions of different formulations are also provided in Example 4 herein, with all calculated values being greater than 1.6%.

When including microbial oil as a source of EPA (and optionally, DHA), the amount of fish oil included in the aquaculture feed composition may be reduced, and may even be completely eliminated. A microbial source of EPA (and optionally, DHA) and a vegetable oil, and/or microalgae oil, may together replace fish oil in an aquaculture feed composition. Replacing fish oil in aquaculture feed compositions with oils that are produced by readily renewable microbes and plants removes harvesting pressure from wild fish. Aquaculture feed compositions that are formulated with renewable sources of oil will support sustainable aquaculture.

### EXAMPLES

The present invention is further defined in the following Examples. It should be understood that these Examples, while indicating preferred embodiments of the invention, are given by way of illustration only. It will be understood by those skilled in the art that the invention is capable of numerous modifications, substitutions, and rearrangements without departing from the spirit of essential attributes of the invention. Reference should be made to the appended claims, rather than to the foregoing specification, as indicating the scope of the invention.

The meaning of abbreviations is as follows: “kb” means kilobase(s), “bp” means base pairs, “nt” means nucleotide(s), “hr” means hour(s), “min” means minute(s), “sec” means second(s), “d” means day(s), “L” means liter(s), “ml” means milliliter(s), “μL” means microliter(s), “μg” means microgram(s), “ng” means nanogram(s), “mM” means millimolar, “μM” means micromolar, “nm” means nanometer(s), “μmol” means micromole(s), “DCW” means dry cell weight, “TFAs” means total fatty acids. “FAMEs” means fatty acid methyl esters, SU^{R} means sulfonylurea resistant.

### General Methods

All aquaculture feed formulations and feed ingredients were obtained from and/or produced by Nofima Ingrediens, Kierreidviken 16, NO-5141 Fvllingsdalen, Norway (“Nofima”). Fish meal, sunflower meal, hydrolyzed feather meal, corn gluten, soybean meal, pea protein, Carophyll Pink comprising 10% astaxanthin, and yttrium oxide were obtained from Nofima.

Lipid Analysis:

Lipids were extracted using the Folch method (Folch et al., J. Biol. Chem., 226:497 (1957)). Following extraction, the chloroform phase was dried under N₂ and the residual lipid extract was redissolved in benzene, and then transmethylated overnight with 2,2-dimethoxypropane and methanolic HCl at room temperature, as described by Mason, M. E. and G. R. Waller (J. Agric. Food Chem., 12:274-278 (1964)) and by Hoshi et al. (J. Lipid Res., 14:599-601 (1973)). The methyl esters of fatty acids thus formed were separated in a gas chromatograph (Hewlett Packard 6890) with a split injector, a SGE BPX70 capillary column (having a length of 60 m, an internal diameter of 0.25 mm and a film thickness of 0.25 m) with flame ionization detector. The carrier gas was helium. The injector and detector temperatures were 280° C. The oven temperature was raised from 50° C. to 180° C. at the rate of 10° C./min, and then raised to 240° C. at the rate of 0.7° C./min. All GC results were analyzed using HP ChemStation software (Hewlett-Packard Co.). The relative quantity of each fatty acid present was determined by measuring the area under the peak of the FAME corresponding to that fatty acid, and calculating the percentage relative to the sum of all integrated peaks.

Yarrowia lipolytica Strains:

Y. lipolytica strain Y4305 was derived from wild type Yarrowia lipolytica ATCC #20362. Strain Y4305 was previously described in U.S. Pat. Appl. Pub. No. 2009-0093543-A1, the disclosure of which is hereby incorporated in its entirety. The final genotype of strain Y4305 with respect to wild type Yarrowia lipolytica ATCC #20362 is SCP2- (YALI0E01298g), YALI0C18711g-, Pex10-, YALI0F24167g-, unknown 1-, unknown 3-, unknown 8-, GPD::FmD12::Pex20, YAT1::FmD12::OCT, GPM/FBAIN::FmD12S::OCT, EXP1::FmD12S::Aco, YAT1::FmD12S::Lip2, YAT1::ME3S::Pex16, EXP1::ME3S::Pex20 (3 copies), GPAT::EgD9e::Lip2, EXP1::EgD9eS::Lip1, FBAINm::EgD9eS::Lip2, FBA::EgD9eS::Pex20, GPD::EgD9eS::Lip2, YAT1::EgD9eS::Lip2, YAT1::E389D9eS::OCT, FBAINm::EgD8M::Pex20, FBAIN::EgD8M::Lip1 (2 copies), EXP1::EgD8M::Pex16, GPDIN::EgD8M::Lip1, YAT1::EgD8M::Aco, FBAIN::EgD5::Aco, EXP1::EgD5S::Pex20, YAT1::EgD5S::Aco, EXP1::EgD5S::ACO, YAT1::RD5S::OCT, YAT1::PaD17S::Lip1, EXP1::PaD17::Pex16, FBAINm::PaD17::Aco, YAT1::YICPT1::ACO, GPD::YICPT1::ACO. Chimeric genes in the above strain genotype are represented by the notation system “X::Y::Z”, where X is the promoter region, Y is the coding region, and Z is the terminator, which are all operably linked to one another. Abbreviations are as follows: FmD12 is a Fusarium moniliforme delta-12 desaturase coding region [U.S. Pat. No. 7,504,259]; FmD12S is a codon-optimized delta-12 desaturase coding region derived from Fusarium moniliforme (U.S. Pat. No. 7,504,259); MESS is a codon-optimized C_{16/18} elongase coding region derived from Mortierella alpina (U.S. Pat. No. 7,470,532); EgD9e is a Euglena gracilis delta-9 elongase coding region (U.S. Pat. No. 7,645,604); EgD9eS is a codon-optimized delta-9 elongase coding region derived from Euglena gracilis (U.S. Pat. No. 7,645,604); E389D9eS is a codon-optimized delta-9 elongase coding region derived from Eutreptiella sp. CCMP389 (U.S. Pat. No. 7,645,604); EgD8M is a synthetic mutant delta-8 desaturase coding region (U.S. Pat. No. 7,709,239) derived from Euglena gracilis (U.S. Pat. No. 7,256,033); EgD5 is a Euglena gracilis delta-5 desaturase coding region (U.S. Pat. No. 7,678,560); EgDSS is a codon-optimized delta-5 desaturase coding region derived from Euglena gracilis (U.S. Pat. No. 7,678,560); RD5S is a codon-optimized delta-5 desaturase coding region derived from Peridinium sp. CCMP626 (U.S. Pat. No. 7,695,950); PaD17 is a Pythium aphanidermatum delta-17 desaturase coding region (U.S. Pat. No. 7,556,949); PaD17S is a codon-optimized delta-17 desaturase coding region derived from Pythium aphanidermatum (U.S. Pat. No. 7,556,949); and, YICPT1 is a Yarrowia lipolytica diacylglycerol cholinephosphotransferase coding region (Inn App. Pub. No. WO 2006/052870).

Total fatty acid content of the Y4305 cells was 27.5% of dry cell weight [“TFAs % DCW”], and the lipid profile was as follows, wherein the concentration of each fatty acid is as a weight percent of TFAs [“% TFAs”]: 16:0 (palmitate)—2.8, 16:1 (palmitoleic acid)—0.7, 18:0 (stearic acid)—1.3, 18:1 (oleic acid)—4.9, 18:2 (LA)—17.6, ALA—2.3, EDA—3.4, DGLA—2.0, ARA—0.6, ETA—1.7 and EPA—53.2.

Yarrowia lipolytica strain Y4305 F1B1 was derived from Y. lipolytica strain Y4305. Specifically, strain Y4305 was subjected to transformation with a dominant, non-antibiotic marker for Y. lipolytica based on sulfonylurea resistance [“SU^{R}”]. The marker gene was a native acetohydroxyacid synthase (“AHAS” or acetolactate synthase; E.C. 4.1.3.18) that has a single amino acid change, i.e., W497L, that confers sulfonylurea herbicide resistance (SEQ ID NO:292 of Intl. App. Pub. No. WO 2006/052870). AHAS is the first common enzyme in the pathway for the biosynthesis of branched-chain amino acids and it is the target of the sulfonylurea and imidazolinone herbicides.

Random integration of the SU^{R} marker into Yarrowia strain Y4305 was used to identify those cells having increased lipid content when grown under oleaginous conditions relative to the parent Y4305 strain. Specifically, the mutated AHAS gene described above was introduced into strain Y4305 cells as a linear DNA fragment. The AHAS gene integrates randomly throughout the chromosome at any location that contains a double stranded-break that is also bound by the Ku enzymes. Non-functional genes or knockout mutations may be generated when the SU^{R} marker fragment integrates within the coding region of a gene. Every gene is a potential target for down-regulation. Thus, a random integration library in Yarrowia Y4305 cells was made and SU^{R} mutant cells were identified. Strains were isolated and evaluated based on DCW (g/L), FAMEs % DCW, EPA % TFAs and EPA % DCW.

Strain Y4305 F1B1 had 6.9 g/L DCW, 27.9 TFAs % DCW, 53.1 EPA % TFAs, and 14.8 EPA % DCW as compared to 6.8 g/L DCW, 25.1 TFAs % DCW, 50.3 EPA % TFAs, and 12.7 EPA % DCW for the control Y4305 strain, when both strains were evaluated in triple flask analysis. When grown in a two liter fermentation (parameters similar to those of U.S. Pat. Appl. Pub. No. 2009-009354-A1, Example 10), average EPA productivity [“EPA % TFAs”] for strain Y4305 was 50-56, as compared to 50-52 for strain Y4305-F1B1. Average lipid content [“TFAs % DCW”] for strain Y4305 was 20-25, as compared to 28-32 for strain Y4305-F1B1. Thus, lipid content was increased 29-38% in strain Y4503-F1B1, with minimal impact upon EPA productivity.

Yarrowia Biomass Preparation:

Inocula were prepared from frozen cultures of either Yarrowia lipolytica strain Y4305 or strain Y4305 F1B1 in a shake flask. After an incubation period, the culture was used to inoculate a seed fermentor. When the seed culture reached an appropriate target cell density, it was then used to inoculate a larger fermentor. The fermentation was run as a 2-stage fed-batch process. In the first stage, the yeast were cultured under conditions that promote rapid growth to a high cell density; the culture medium comprised glucose, various nitrogen sources, trace metals and vitamins. In the second stage, the yeast were starved for nitrogen and continuously fed glucose to promote lipid and PUFA accumulation. Process variables including temperature (controlled between 30-32° C.), pH (controlled between 5-7), dissolved oxygen concentration and glucose concentration were monitored and controlled per standard operating conditions to ensure consistent process performance and final PUFA oil quality.

One of skill in the art of fermentation will know that variability will occur in the oil profile of a specific Yarrowia strain, depending on the fermentation run itself, media conditions, process parameters, scale-up, etc., as well as the particular time-point in which the culture is sampled (see, e.g., U.S. Pat. Appl. Pub. No. 2009-0093543-A1).

Antioxidants were optionally added to the fermentation broth prior to processing to ensure the oxidative stability of the EPA oil. After fermentation, the yeast biomass was dewatered and washed to remove salts and residual medium, and to minimize lipase activity. Prior to drum drying, ethoxyquin (600 ppm) was added to the biomass. Then, the biomass was drum dried (typically with 80 psig steam) to reduce the moisture content to less than 5% to ensure oil stability during short term storage and transportation. The drum dried biomass was in the form of flakes.

Extrusion of Yarrowia Biomass Flakes:

Dried biomass flakes were fed into an extruder, preferably a twin screw extruder with a length suitable for accomplishing the operations described below, normally having a length to diameter [“L/D”] ratio between 21-39. The first section of the extruder was used to feed and transport the biomass. The following section served as a compaction zone designed to compact the biomass using bushing elements with progressively shorter pitch length. After the compaction zone, a compression zone followed, which served to impart most of the mechanical energy required for cell disruption. This zone was created using flow restriction, either in the form of reverse screw elements or kneading elements. Finally, the disrupted biomass was discharged through the last barrel which was open at the end, thus producing no backpressure in the extruder.

Feed Formulation:

The extruded biomass was then formulated with other feed ingredients (infra) and extruded into pellets using a 4.5 mm die opening, giving approximately 5.5 mm pellets after expansion. Yttrium oxide [Y₂O₃] (100 ppm) was added to all diets as an inert marker for digestibility determination. Vegetable oil was added post-extrusion to the pellets in accordance with the diet composition.

### Example 1 (Comparative)

### EPA and DHA Content of Commercially Sold Salmon

EPA and DHA levels were measured in fresh and frozen retail salmon fillets on three different occasions (i.e., “Set #1”, “Set #2” and “Set #3”, respectively) over a period of 2 years. A total of 52 retail fillet samples were tested, including farmed and wild fish. Fillets were purchased from various grocery store chains, as well as higher quality fish mongers as listed in Table 3. The sources of fish were: Janssen's Supermarket (Greenville, Del.), Hill's Fish Market (Kennett Square, Pa.), Shoprite Supermarket (Wilmington, Del.), Giant Supermarket (Toughkenneamon, Pa.), Wegman's (Downingtown, Pa.), Gadeleto's (West Chester, Pa.), Trader Joe's (Wilmington, Del.), Fresh Market (Glenn Mills, Pa.), Feby's Fishery (Wilmington, Del.), Superfresh (Kennett Square, Pa.), Acme (Kennett Square, Pa.), Genuardi's (Kennett Square, Pa.) and Hadfield's Seafood (Wilmington, Del.). AquaChile samples were from Empresas AquaChile S.A. (Puerto Montt, Chile).

Purchased salmon fillets were skinned to remove most of the brown layer underneath the skin and cut transversely to yield a ˜100 g portion nearest the head, so that analyses were performed on the red muscle portion of the fish only. Each portion was then blended in a Waring blender for one min to yield a salmon paste. This paste was immediately frozen in dry ice for shipment and lipid analysis, as described in the General Methods. Specifically, lipids were extracted and analyzed to determine the percent of EPA and DHA in the total fatty acids [“EPA % TFAs” and “DHA % TFAs”, respectively] of the filets. Grams (g) of fatty acid per 100 g of filet were then calculated from the % of each fatty acid in the total fat of the filet and the % total fat in the filet as determined by the Folch method (General Methods).

Table 3 shows the grams of EPA per 100 g of filet, the grams of DHA per 100 g of filet, and the grams of EPA plus DHA [“EPA+DHA”] per 100 g of filet, as well as the Average values within each Set. The ratio of EPA:DHA is also provided for each fillet and Set.

TABLE 3
EPA And DHA, Quantified as Grams Per 100 Grams Of Tissue,
In Commercially Purchased Filets

| Analysis | | | | | EPA + | EPA:DHA |
|---|---|---|---|---|---|---|
| Set | Source | Fish | EPA | DHA | DHA | Ratio |
| Set #1 | Wegman's | Farmed | 0.33 | 0.56 | 0.89 | 0.59:1 |
| | | Atlantic | | | | |
| | Wegman's | Farmed | 0.96 | 0.88 | 1.84 | 1.09:1 |
| | | Atlantic | | | | |
| | Wegman's | Farmed | 0.78 | 1.51 | 2.29 | 0.52:1 |
| | | Atlantic | | | | |
| | Janssen's | Farmed | 0.61 | 0.51 | 1.12 | 1.20:1 |
| | | Atlantic | | | | |
| | Janssen's | Farmed | 0.49 | 0.39 | 0.88 | 1.25:1 |
| | | Atlantic | | | | |
| | Janssen's | Wild | 0.18 | 0.45 | 0.63 | 0.40:1 |
| | | Sockeye | | | | |
| | Hadfield's | Farmed | 0.79 | 0.78 | 1.57 | 1.01:1 |
| | | Atlantic | | | | |
| | Hadfield's | Farmed | 0.36 | 0.62 | 0.98 | 0.58:1 |
| | | Atlantic | | | | |
| | Feby's | Farmed | 0.41 | 0.55 | 0.96 | 0.74:1 |
| | | Atlantic | | | | |
| | Hills | Farmed | 0.77 | 0.70 | 1.48 | 1.10:1 |
| | | Atlantic | | | | |
| | Hills | Wild | 0.32 | 0.62 | 0.94 | 0.51:1 |
| | | Sockeye | | | | |
| | Genuardi's | Farmed | 1.18 | 1.61 | 2.79 | 0.74:1 |
| | | Atlantic | | | | |
| | Hills | Wild | 0.29 | 0.43 | 0.72 | 0.68:1 |
| | | Sockeye | | | | |
| | Giant | Farmed | 0.80 | 1.07 | 1.88 | 0.75:1 |
| | | Atlantic | | | | |
| | Giant | Farmed | 0.67 | 0.77 | 1.45 | 0.87:1 |
| | | Atlantic | | | | |
| | Superfresh | Farmed | 1.41 | 1.38 | 2.79 | 1.02:1 |
| | | Atlantic | | | | |
| | Superfresh | Farmed | 0.72 | 1.36 | 2.08 | 0.53:1 |
| | | Atlantic | | | | |
| | Gadeleto's | Farmed | 0.38 | 0.42 | 0.80 | 0.91:1 |
| | | Atlantic | | | | |
| | Trader Joe's | Wild keta | 0.16 | 0.39 | 0.54 | 0.41:1 |
| | Average | | 0.62 | 0.81 | 1.43 | 0.77:1 |
| Set #2 | Janssen's | Farmed | 1.40 | 1.60 | 3.00 | 0.88:1 |
| | | Atlantic | | | | |
| | Hadfield's | Farmed | 1.60 | 1.90 | 3.50 | 0.84:1 |
| | | Atlantic | | | | |
| | Janssen's | Wild | 0.20 | 0.30 | 0.50 | 0.67:1 |
| | | Alaskan | | | | |
| | | King | | | | |
| | Genuardi's | Farmed | 0.90 | 1.20 | 2.10 | 0.75:1 |
| | | Atlantic | | | | |
| | Hills | Wild | 0.20 | 0.50 | 0.70 | 0.40:1 |
| | | Sockeye | | | | |
| | Hadfield's | Wild | 1.50 | 1.50 | 3.00 | 1.00:1 |
| | | Alaskan | | | | |
| | | King | | | | |
| | Superfresh | Farmed | 0.40 | 0.60 | 1.00 | 0.67:1 |
| | | Atlantic | | | | |
| | Acme | Farmed | 0.50 | 0.90 | 1.40 | 0.56:1 |
| | | Atlantic | | | | |
| | Janssen's | Farmed | 0.60 | 0.70 | 1.30 | 0.86:1 |
| | | Atlantic | | | | |
| | Gadeleto's | Wild King | 1.50 | 1.60 | 3.10 | 0.94:1 |
| | Fresh Market | Wild | 0.30 | 0.70 | 1.00 | 0.43:1 |
| | | Sockeye | | | | |
| | Fresh Market | Farmed | 0.10 | 0.40 | 0.50 | 0.25:1 |
| | | Steelhead | | | | |
| | Fresh Market | Farmed | 0.80 | 1.30 | 2.10 | 0.62:1 |
| | | Atlantic | | | | |
| | Wegman's | Farmed | 0.60 | 0.90 | 1.50 | 0.67:1 |
| | | Atlantic | | | | |
| | Giant | Farmed | 0.60 | 0.90 | 1.50 | 0.67:1 |
| | | Atlantic | | | | |
| | Average | | 0.75 | 1.0 | 1.75 | 0.68:1 |
| Set #3 | Wegman's | Farmed | 0.96 | 1.1 | 2.06 | 0.87:1 |
| | | Atlantic | | | | |
| | Wegman's | Farmed | 0.97 | 1.1 | 2.07 | 0.88:1 |
| | | Atlantic | | | | |
| | Trader Joe's | Wild | 0.25 | 0.76 | 1.01 | 0.33:1 |
| | | Coho | | | | |
| | Janssen's | Farmed | 1.22 | 1.75 | 2.97 | 0.70:1 |
| | | Atlantic | | | | |
| | Shoprite | Farmed | 1.41 | 1.3 | 2.71 | 1.08:1 |
| | | Atlantic | | | | |
| | Hills | Farmed | 1.22 | 1.35 | 2.57 | 0.90:1 |
| | | Atlantic | | | | |
| | Giant | Farmed | 0.64 | 1 | 1.64 | 0.64:1 |
| | | Atlantic | | | | |
| | Giant | Farmed | 0.21 | 0.4 | 0.61 | 0.53:1 |
| | | Atlantic | | | | |
| | Giant | Wild | 0.18 | 0.4 | 0.58 | 0.45:1 |
| | | Sockeye | | | | |
| | AquaChile^{a} | Farmed | 1.47 | 1.35 | 2.82 | 1.09:1 |
| | | Atlantic | | | | |
| | AquaChile^{b} | Farmed | 1.65 | 1.46 | 3.11 | 1.13:1 |
| | | Atlantic | | | | |
| | AquaChile¹ | Farmed | 1.22 | 1.25 | 2.47 | 0.98:1 |
| | | Atlantic | | | | |
| | AquaChile² | Farmed | 1.38 | 1.33 | 2.71 | 1.04:1 |
| | | Atlantic | | | | |
| | AquaChile³ | Farmed | 1.29 | 1.25 | 2.54 | 1.03:1 |
| | | Atlantic | | | | |
| | AquaChile⁴ | Farmed | 1.21 | 1.24 | 2.45 | 0.98:1 |
| | | Atlantic | | | | |
| | AquaChile⁵ | Farmed | 0.82 | 0.89 | 1.71 | 0.92:1 |
| | | Atlantic | | | | |
| | AquaChile⁶ | Farmed | 0.6 | 0.72 | 1.32 | 0.83:1 |
| | | Atlantic | | | | |
| | Average | | 0.98 | 1.09 | 2.07 | 0.85:1 |

AquaChile^{a} and AquaChile^{b} are duplicates of the same sample; and, AquaChile¹, AquaChile², AquaChile³, AquaChile⁴, AquaChile⁵ and AquaChile⁶ are different cuts from the same fish starting at the head end (1) and ending at the tail end (6).

In general, the amount of EPA plus DHA was found to correlate with the amount of total fat. Wild salmon samples had lower levels of total fat than farmed salmon samples, and also had lower levels of EPA plus DHA. The average EPA+DHA in Set #1, Set #2 and Set #3 ranged from 1.43 to 2.07 and the average EPA:DHA ratio ranged from 0.68:1 to 0.85:1. The range of EPA:DHA ratios over all the fish tested, irrespective of the particular data set, was 0.25:1 to 1.25:1. EPA:DHA ratios equal to or greater than 1.2:1 to 1.25:1 represent less than 4% of the total number of samples and there are no instances of fish with EPA:DHA ratios greater than 1.25:1. The range of EPA+DHA (g/100 g of fillet) over all the fish tested, irrespective of the particular data set, was 0.5 to 3.5.

### Example 2

### Oil Composition of Yarrowia lipolytica Strain Y4305 F1B1 Biomass in Comparison to Fishmeal, Fish Oil and Rapeseed Oil

Yarrowia lipolytica strain Y4305 F1B1 biomass was prepared and made into flakes, as described in General Methods. Oil was extracted from the whole dried flakes by placing 7 g of dried flakes and 20 mL of hexane in a 35 mL steel cylinder. Three steel ball bearings (0.5 cm diameter) were then added to the cylinder and the cylinder was placed on a vibratory shaker. After 1 hr of vigorous shaking, the disrupted biomass was allowed to settle and the solution of oil in hexane was poured off to yield a clear yellow liquid. This liquid was then poured into a separate tube and subjected to a nitrogen stream to evaporate the hexane, thereby leaving the oil phase in the tube. It was determined that about 34% of the biomass was oil. The composition of the oil was analyzed by GC, as described in the General Methods.

In addition, the fatty acid composition of fish meal oil, fish oil and rapeseed oil was similarly analyzed by GC.

Lipids were extracted as described in General Methods above. A comparison of fatty acids present in the Yarrowia Y4305 F1B1 biomass, fish meal, fish oil, and rapeseed oil is shown in Table 4. The concentration of each fatty acid is presented as a weight percent of total fatty acids [“% TFAs”].

TABLE 4
Lipid Composition Of Various Oils

| | Fatty Acid | Fish | | | Yarrowia |
|---|---|---|---|---|---|
| | Common | meal | Fish | Rapeseed | Y4305 |
| Fatty acid | Name | oil | oil | oil | F1B1 oil |
| C14:0 | Myristic | 3.7 | 6.8 | 0.1 | 0.1 |
| | acid | | | | |
| C16:0 | Palmitic | 10.8 | 10.5 | 4.4 | 2.8 |
| | Acid | | | | |
| C17:0 | — | nd | nd | nd | 0.3 |
| C18:0 | Stearic | 1.7 | 1.1 | 1.8 | 2.5 |
| | acid | | | | |
| C20:0 | — | 0.1 | 0.1 | 0.6 | 0.8 |
| C22:0 | — | <0.1 | 0.1 | 0.3 | 1.1 |
| C24:0 | — | nd | nd | nd | 0.6 |
| C16:1, n-7 | — | 3.2 | 4.4 | 0.2 | 0.5 |
| C18:1, n-9 | — | nd | nd | nd | 4.7 |
| C18:1, n-7 | — | nd | nd | nd | 0.4 |
| C18:1, | — | 9.4 | 11.9 | 59.1 | nd |
| (n-9) + (n-7) + (n-5) | | | | | |
| C20:1, (n-9) + (n-7) | — | 7.6 | 13.9 | 1.7 | nd |
| C22:1, | — | 9.4 | 20.6 | 0.9 | nd |
| (n-11) + (n-9) + (n-7) | | | | | |
| C24:1, n-9 | — | 0.8 | 0.9 | 0.1 | nd |
| C16:2, n-4 | — | 0.3 | 0.3 | <0.1 | nd |
| C16:3, n-4 | — | 0.3 | 0.2 | <0.1 | nd |
| C16:4, n-1 | — | 0.1 | 0.1 | <0.1 | nd |
| C18:2, n-6 | LA | 1.1 | 1.1 | 19.3 | 20.3 |
| C18:3, n-6 | GLA | 0.1 | 0.1 | <0.1 | 1.0 |
| C18:3, n-4 | — | nd | nd | nd | 0.2 |
| C20:2, n-6 | EDA | 0.2 | 0.2 | 0.1 | 3.2 |
| C20:3, n-6 | DGLA | 0.1 | 0.1 | <0.1 | 1.9 |
| C20:4, n-6 | ARA | 0.6 | 0.3 | <0.1 | 0.5 |
| C22:4, n-6 | DTA | <0.1 | <0.1 | <0.1 | nd |
| C18:3, n-3 | ALA | 0.7 | 0.8 | 8.4 | 3.4 |
| C18:4, n-3 | STA | 2 | 1.9 | <0.1 | nd |
| C20:1, n-9 | — | nd | nd | nd | 0.2 |
| C20:1, n-7 | — | nd | nd | nd | 0.6 |
| C20:3, n-3 | ETrA | 0.1 | 0.1 | <0.1 | 0.8 |
| C20:3, n-9 | — | nd | nd | nd | 0.3 |
| C20:4, n-3 | ETA | 0.5 | 0.5 | <0.1 | 0.0 |
| C20:5, n-3 | EPA | 7.4 | 5.2 | <0.1 | 46.8 |
| C21:5, n-3 | — | 0.3 | 0.3 | <0.1 | nd |
| C22:1, n-7 | — | nd | nd | nd | 2.0 |
| C22:1, n-11 | — | nd | nd | nd | 0.5 |
| C22:5, n-3 | DPA | 0.6 | 0.6 | <0.1 | 2.3 |
| C22:6, n-3 | DHA | 10.6 | 5.7 | <0.1 | nd |

* nd = not detected

The EPA:DHA ratios for the fishmeal and fish oil samples were calculated to be 0.7 and 0.9, respectively. In rapeseed oil, the ratio of EPA and DHA was not meaningful since EPA and DHA levels were below detection limits of the analysis. In the Yarrowia Y4305 F1B1 oil, EPA was very high at 46.8% of total fatty acids, while DHA was not detected.

EPA was determined to be about 15% of the Yarrowia Y4305 F1B1 biomass, since EPA constituted 46.8% of the TFAs and fatty acids (i.e., oil) constituted about 28-34% of the biomass. Thus, 20% of Yarrowia Y4305 F1B1 biomass in an aquaculture feed composition formulation would provide about 3% of EPA by weight in the aquaculture feed composition.

### Example 3

### Comparison of Aquaculture Meat Products from Salmon Fed a Standard Feed Formulation or Feed Formulations Including Variable Percentages of Yarrowia lipolytica Y4305 F1B1 Biomass

Atlantic salmon were raised in aquaculture using either standard commercial aquaculture feed formulations (“Commercial Diet”) or aquaculture feed formulations comprising two different amounts of Yarrowia lipolytica Y4305 F1B1 biomass (i.e., “Diet 1” and “Diet 2”). The Commercial Diet used herein was a combination of “Optiline S1200” and “Optiline S2500” (Nofima Ingredients, Kjerreidviken 16, NO-5141, Fyllingsdalen Norway). Specifically, in the control, Optiline S1200 was fed to smolts up to about 1 kg, then fish were fed Optiline S2500 for growth to market size of about 2.5-3 kg.

### Preparation of Feed Formulations Including Variable Percentages of Yarrowia lipolytica Y4305 F1B1 Biomass

Standard feed ingredients (Nofima Ingrediens, Kjerreidviken 16, NO-5141, Fyllingsdalen Norway) were formulated with two different amounts of Yarrowia lipolytica Y4305 F1B1 biomass, as shown in Table 5. Specifically, Diet 1 comprised a sufficient amount of Y. lipolytica Y4305 F1B1 biomass to provide 1% EPA as a percent of the total weight of the aquaculture feed composition, while Diet 2 comprised a sufficient amount of Y. lipolytica Y4305 F1B1 biomass to provide 3% EPA as a percent of the total weight of the aquaculture feed composition. Calculations were based on the assumption that Y. lipolytica Y4305 F1B1 biomass had a total lipid content of 28 (i.e., “TFAs % DCW”), with the concentration of EPA as a percent of the total fatty acids [“EPA % TFAs”] equivalent to 53. Thus, the cellular content of EPA as a percent of the dry cell weight [“EPA % DCW”] was calculated as: (EPA % TFAs)*(TFAs % DCW)]/100, or 15 EPA % DCW. No fish oil was included in these formulations.

TABLE 5
Components Of Feed Formulations Including Variable
Percentages Of Yarrowia lipolytica Y4305 F1B1 Biomass

| | |
|---|---|
| Diet 1 | Diet 2 |

Formulation, %

| | | |
|---|---|---|
| Fish meal | 23.14 | 23.14 |
| Hydrolyzed feather meal | 6.40 | 5.00 |
| Wheat gluten | 7.70 | 11.00 |
| Soy protein concentrate | 5.86 | 2.00 |
| Pea protein | 7.70 | 6.10 |
| Yarrowia lipolytica Y4305 | 7.00 | 20.00 |
| F1B1 biomass | | |
| Soybean oil | 25.50 | 21.65 |
| Wheat | 12.20 | 6.61 |
| Vitamin E | 0.04 | 0.04 |
| Vitamin mix | 2.00 | 2.00 |
| Mineral mix | 0.40 | 0.40 |
| L-Lysine HCl | 1.0 | 1.0 |
| Ca(H₂PO₄)₂ | 0.86 | 0.86 |
| Choline chloride | 0.10 | 0.10 |
| Carophyll Pink (10% | 0.06 | 0.06 |
| astaxanthin) | | |
| Vitamin C (35%) | 0.03 | 0.03 |
| Yttrium oxide | 0.01 | 0.01 |

### Comparison of Fatty Acid Composition in the Optiline S1200/S2500 Commercial Feed Formulation and Feed Formulations Including Variable Percentages of Yarrowia lipolytica Y4305 F1B1 Biomass

The fatty acid contents of the Optiline S1200 and Optiline S2500 Commercial Diets were compared to those of Diet 1 and Diet 2, prepared supra, as shown in Table 6. Specifically, three different production lots of Diet 1, five different production lots of Diet 2 and one sample each of Optiline S1200 and Optiline S2500 were analyzed for fatty acid content, based on lipid extraction and GC analysis (General Methods).

For each feed formulation analyzed, Table 6 provides a summary of each fatty acid as a percent of the total fatty acids [“% TFAs”], as well as the EPA, DHA and EPA+DHA content as a percent of the total feed composition [“Fatty Acid, g/100 g”]. The latter values as a percent of the total feed composition were determined by multiplying the EPA % TFAs, DHA % TFAs and (EPA % TFAs+DHA % TFAs) by 0.32, since all feeds contained about 32% fat. The EPA:DHA ratio within each composition was calculated based on the EPA and DHA as a percent of the total feed composition.

TABLE 6
Fatty Acid Composition In Aquaculture Feed Formulations Comprising Variable Concentrations Of Yarrowia
Y4305 F1B1 Biomass And A Commercial Feed Formulation

| | Diet 1 | | | Diet 2 | | | | | Optiline | Optiline |
|---|---|---|---|---|---|---|---|---|---|---|
| Production Lot | 1 | 2 | 3 | 1 | 2 | 3 | 4 | 5 | S1200 | S2500 |

Fatty Acid, % TFAs

| | | | | | | | | | | |
|---|---|---|---|---|---|---|---|---|---|---|
| C14:0 | 0.7 | 0.6 | 0.6 | 0.7 | 0.7 | 0.6 | 0.6 | 0.6 | 3.7 | 3.8 |
| C14:1, n-5 | 0.1 | 0.1 | 0.1 | 0.0 | 0.1 | nd | nd | nd | nd | 0.2 |
| C15:0 | 0.0 | 0.0 | 0.0 | 0.1 | 0.1 | 0.1 | 0.1 | 0.1 | 0.1 | 0.3 |
| C16:0 | 11.2 | 11.2 | 11.0 | 10.1 | 10.2 | 10.5 | 10.4 | 5.7 | 10.7 | 10.3 |
| C16:1, n-7 | 0.6 | 0.5 | 0.5 | 0.6 | 0.7 | 0.7 | 0.7 | nd | 0.1 | nd |
| C16:1, n-9 | nd | nd | nd | nd | nd | nd | nd | 0.8 | nd | nd |
| C17:0 | 0.1 | 0.1 | 0.1 | 0.1 | 0.2 | 0.1 | 0.2 | 0.1 | 0.6 | 0.2 |
| C16:2, n-6 | 0.1 | 0.1 | 0.1 | 0.1 | 0.1 | 0.2 | 0.2 | nd | nd | 0.3 |
| C17:1, n-7 | 0.1 | 0.1 | 0.1 | 0.1 | 0.1 | 0.1 | 0.1 | 0.1 | 0.7 | 0.2 |
| C18:0 | 3.0 | 3.0 | 3.0 | 2.9 | 2.9 | 2.9 | 2.9 | 1.5 | 2.7 | 2.3 |
| C18:1, n-9 | 19.0 | 19.1 | 18.6 | 16.7 | 16.8 | 17.3 | 17.4 | 41.5 | 33.3 | 28.9 |
| C18:1, n-7 | 1.4 | 1.4 | 1.3 | 1.3 | 1.3 | 1.3 | 1.2 | 2.0 | 3.1 | 2.3 |
| C18:2, n-6 | 0.1 | 0.1 | 0.1 | 0.1 | 0.1 | 0.1 | 0.1 | nd | nd | nd |
| C18:2, n-6 | 47.0 | 47.6 | 46.2 | 42.3 | 42.8 | 44.0 | 44.0 | 17.6 | 11.8 | 10.7 |
| C18:3, n-6 | 0.1 | 0.1 | 0.2 | 0.3 | 0.3 | 0.3 | 0.4 | nd | 0.2 | 0.1 |
| C18:3, n-3 | 5.7 | 5.7 | 5.6 | 5.3 | 5.3 | 5.4 | 5.4 | 6.3 | 6.0 | 5.2 |
| C20:0 | 0.3 | 0.3 | 0.3 | 0.3 | 0.3 | 0.3 | 0.3 | 0.1 | 0.4 | 2.7 |
| C20:1, n-11 | 0.2 | 0.2 | 0.1 | 0.2 | 0.2 | 0.1 | 0.2 | 0.2 | 1.1 | 0.4 |
| C20:4, n-3 | 0.2 | 0.1 | 0.1 | 0.1 | nd | 0.1 | 0.2 | nd | 0.3 | nd |
| C20:1, n-9 | 1.0 | 0.9 | 0.9 | 1.0 | 1.0 | 0.9 | 1.0 | 0.1 | 2.2 | 5.5 |
| C18:4, n-3 | 0.1 | 0.1 | 0.1 | 0.2 | 0.2 | 0.3 | 0.3 | nd | 0.2 | nd |
| C20:2, n-6 | 0.3 | 0.3 | 0.4 | 0.7 | 0.6 | 0.5 | 0.5 | 0.8 | 0.1 | 0.2 |
| C20:3, n-6 | 0.1 | 0.1 | 0.1 | 0.2 | 0.3 | 0.2 | 0.2 | 0.3 | nd | 0.1 |
| C20:4, n-6 | 0.1 | 0.1 | 0.1 | 0.2 | 0.2 | 0.1 | nd | 0.2 | nd | 0.2 |
| C20:3, n-3 | 0.1 | 0.1 | 0.1 | 0.2 | 0.1 | 0.1 | 0.1 | 0.2 | 0.4 | 0.1 |
| C22:0 | 0.4 | 0.4 | 0.5 | 0.5 | 0.5 | 0.5 | 0.5 | 0.6 | 0.5 | 0.8 |
| C22:1, n-7 | 0.2 | 0.2 | 0.2 | 0.4 | 0.4 | 0.4 | 0.4 | nd | 0.4 | nd |
| C22:1, n-11 | 1.2 | 1.2 | 1.2 | 1.4 | 1.3 | 1.2 | 1.2 | 1.2 | 2.1 | 5.6 |
| C22:1, n-9 | 0.1 | 0.2 | 0.1 | 0.1 | 0.1 | 0.1 | 0.1 | 0.4 | 0.5 | nd |
| C20:5, n-3 [EPA] | 4.0 | 3.7 | 5.4 | 10.2 | 9.8 | 8.3 | 8.2 | 12.0 | 6.5 | 6.3 |
| C24:0 | 0.2 | 0.2 | 0.2 | 0.2 | 0.3 | 0.3 | 0.3 | 0.2 | 0.2 | 0.2 |
| C24:1, n-9 | 0.1 | 0.1 | 0.1 | 0.1 | 0.1 | 0.1 | 0.1 | 0.2 | 0.3 | 0.0 |
| C22:5, n-3 | 0.2 | 0.2 | 0.3 | 0.5 | 0.5 | 0.4 | 0.4 | 0.2 | 0.8 | 1.0 |
| C22:6, n-3 [DHA] | 1.2 | 1.1 | 0.9 | 1.2 | 1.1 | 0.8 | 0.9 | 0.8 | 4.1 | 5.6 |

Fatty Acid, g/100 g

| | | | | | | | | | | |
|---|---|---|---|---|---|---|---|---|---|---|
| EPA | 1.28 | 1.18 | 1.73 | 3.26 | 3.14 | 2.66 | 2.62 | 3.84 | 2.08 | 2.02 |
| DHA | 0.38 | 0.35 | 0.29 | 0.38 | 0.35 | 0.26 | 0.29 | 0.26 | 1.31 | 1.79 |
| EPA + DHA | 1.66 | 1.53 | 2.02 | 3.64 | 3.49 | 2.92 | 2.91 | 4.10 | 3.39 | 3.81 |
| EPA:DHA Ratio | 3.37:1 | 3.37:1 | 5.97:1 | 8.58:1 | 8.97:1 | 10.23:1 | 9.03:1 | 14.77:1 | 1.59:1 | 1.13:1 |

*nd = not detected

As shown above, striking differences exist in the EPA:DHA ratio for Diet 1 and Diet 2 versus the Optiline S1200 and S2500 Commercial Diets. This is primarily due to the fact that the diets with Y. lipolytica Y4305 F1B1 biomass were relatively deficient in DHA (i.e., 0.26-0.38 g DHA/100 g total feed formulation) versus the commercial diets comprising 1.31-1.79 g DHA/100 g total feed formulation. EPA levels were higher in Diet 2 (i.e., 2.62-3.84 g EPA/100 g total feed formulation) than in the commercial diet (i.e., 2.02-2.08 g/100 g).

### Growth of Atlantic Salmon

Duplicate groups of Atlantic salmon smolts were grown in sea cages of 5 m³, and later 7 m³ cages, at Nofima Marine (Averøy, Norway). Fish were fed Diet 1, Diet 2, or the Commercial Diet (Optiline S1200 to 1 kg fish, followed by Optiline S2500) to satiation by automatic feeders. Any dead fish were removed from the cages on a daily basis. After 8 months, the fish reached market size (i.e., 2.3-3 kg) and samples of fish were harvested.

Red muscle samples were prepared and analyzed for dry matter [“DM”] (heated at 105° C., until weight was constant), crude protein (N×6.25, Kjeltech Auto System, Tecator, Höganäs, Sweden), total fat and fatty acid composition (General Methods). The fatty acid profiles of the red muscle samples are presented below in Table 7, wherein the concentration of each fatty acid is presented as grams of fatty acid per 100 g of tissue.

TABLE 7
Chemical And Fatty Acid Composition In Muscle Of 2.3-3 kg
Fish Fed Aquaculture Feed Formulations Comprising
Variable Concentrations Of Yarrowia Y4305 F1B1
Biomass And A Standard Feed Formulation

| | | |
|---|---|---|
| | | Commercial |
| Diet 1 | Diet 2 | Diet |

Chemical composition, %

| | | | |
|---|---|---|---|
| Dry Matter | 34.0 | 33.4 | 34.4 |
| Protein | 19.2 | 19.3 | 19.9 |
| Fat | 16.7 | 15.6 | 16.3 |

Fatty acid composition, g/100 g Tissue

| | | | |
|---|---|---|---|
| C14:0 | 0.07 | 0.09 | 0.38 |
| C15:0 | 0.02 | 0.01 | 0.03 |
| C16:0 | 1.44 | 1.24 | 1.55 |
| C17:0 | 0.02 | 0.02 | 0.02 |
| C17:1, n-7 | 0.01 | 0.01 | 0.02 |
| C18:0 | 0.41 | 0.36 | 0.31 |
| C18:1, n-9 | 2.62 | 2.16 | 4.34 |
| C18:1, n-7 | 0.21 | 0.18 | 0.39 |
| C18:2, n-6 | 5.15 | 4.34 | 1.42 |
| C18:3, n-6 | 0.08 | 0.04 | 0.02 |
| C18:3, n-4 | nd. | 0.01 | 0.03 |
| C18:3, n-3 | 0.56 | 0.51 | 0.62 |
| C20:0 | 0.03 | 0.02 | 0.04 |
| C20:1, n-11 | nd. | 0.09 | 0.29 |
| C20:4, n-3 | nd. | 0.04 | 0.05 |
| C20:1, n-9 | 0.18 | .nd | nd. |
| C20:1, n-7 | 0.01 | 0.01 | 0.02 |
| C20:2, n-6 | 0.29 | 0.28 | 0.11 |
| C20:3, n-6 | 0.14 | 0.09 | 0.03 |
| C20:4, n-6 | 0.02 | 0.02 | 0.04 |
| C20:3, n-3 | 0.04 | 0.04 | 0.06 |
| C22:0 | 0.03 | 0.04 | 0.02 |
| C22:1, n-7 | 0.06 | 0.07 | 0.14 |
| C22:1, n-11 | 0.15 | 0.14 | 0.33 |
| C22:1, n-9 | 0.03 | 0.02 | 0.06 |
| C20:5, n-3 [EPA] | 0.31 | 0.61 | 0.52 |
| C22:2, n-6 | nd. | 0.01 | nd. |
| C24:0 | nd. | .nd | nd. |
| C24:1, n-9 | 0.06 | 0.02 | 0.06 |
| C22:5, n-3 | 0.10 | 0.20 | 0.25 |
| C22:6, n-3 [DHA] | 0.28 | 0.28 | 0.68 |
| EPA + DHA | 0.59 | 0.89 | 1.2 |
| EPA:DHA Ratio | 1.1:1 | 2.17:1 | 0.76:1 |

nd = not detected

The results set forth above in Table 7 were compared to those obtained in Example 1, wherein EPA and DHA content was examined in 52 fillets of commercially sold salmon. Results from this comparison are discussed below.

Specifically, the total amount of EPA+DHA in fillets from fish grown on either Diet 1 or Diet 2 (i.e., 0.59 or 0.89 g EPA+DHA/100 g fillet, respectfully) (supra) fell within the range determined for fillets from commercially sold fish (i.e., 0.5-3.5 EPA+DHA g/100 g fillet) (Example 1).

The EPA:DHA ratio in fish muscle produced after feeding the fish Diet 1 for 8 months (i.e., 1.1:1) was within the range of EPA:DHA ratios observed in commercially sold salmon fillets (i.e., 0.25:1 to 1.25:1) (Example 1), but was increased with respect to the average EPA:DHA ratios observed in commercially sold salmon fillets (i.e., 0.68:1 to 0.85:1) (Example 1). The EPA:DHA ratio in fish muscle produced after feeding the fish Diet 2 for 8 months (i.e., 2.17:1) was substantially increased with respect to the maximum EPA:DHA ratio observed in commercially sold salmon fillets (i.e., 1.25:1).

Based on the results described above, one of skill in the art will appreciate that aquaculture feed formulations prepared with Yarrowia lipolytica Y4305 F1B1 biomass can be utilized as suitable feed for Atlantic salmon raised in aquaculture. The meat products produced therein will comprise an EPA:DHA ratio equal to or greater than 1.4:1, when an appropriate amount of Y. lipolytica Y4305 F1B1 biomass is included in the aquaculture feed formulation.

### Example 4

### Comparison of EPA:DHA Ratios in Alternate Aquaculture Feed Formulations Including Variable Percentages of Yarrowia lipolytica Y4305 F1B1 Biomass

A multi-variant analysis was performed to analyze the total EPA content, total DHA content and ratio of EPA:DHA in a variety of different model aquaculture feed formulations, wherein the aquaculture feed formulations comprised: a) either anchovy oil or menhaden oil, included as 0%, 2%, 5%, 10% or 20% of the total feed on a weight basis; and, b) Yarrowia lipolytica Y4305 F1B1 biomass, included as 10%, 20% or 30% of the total feed on a weight basis.

As previously noted, salmon aquaculture feeds commonly contain either 100% fish oil or mixtures of vegetable oils and fish oils to achieve sufficient caloric value and total omega-3 fatty acid content in the feed formulation. The fish oil can be purified from a variety of different fish species, such as anchovy, capelin, menhaden, herring and cod, and each oil has its own unique fatty acid lipid profile. For example, anchovy oil was assumed herein to comprise 17 EPA % TFAs and 8.8 DHA % TFAs, producing a EPA:DHA ratio of 1.93:1. In contrast, menhaden oil was assumed herein to comprise 11 EPA % TFAs and 9.1 DHA % TFAs, producing a EPA:DHA ratio of 1.21:1.

For the purposes of the calculations herein, the Yarrowia lipolytica Y4305 F1B1 biomass was assumed to comprise 15 EPA % DCW, with no DHA, and biomass of strain Y4305 F1B1 typically contains an average lipid content of about 28-32 TFAs % DCW (see General Methods). Both the concentration of EPA as a percent of the total fatty acids [“EPA % TFAs”] and total lipid content [“TFAs % DCW”] affect the cellular content of EPA as a percent of the dry cell weight [“EPA % DCW”]. That is, EPA % DCW is calculated as: (EPA % TFAs)*(TFAs % DCW)]/100. Based on the assumptions provided above with respect to TFAs % DCW and EPA % DCW, the EPA % TFAs for Yarrowia lipolytica Y4305 F1B1 biomass was calculated to be 50 and DHA % TFAs was zero.

Finally, it was necessary to calculate the total EPA content and total DHA content in the fish meal provided in each aquaculture feed formulation. It was assumed that the aquaculture feed formulations containing menhaden oil also included menhaden fish meal, while the aquaculture feed formulations containing anchovy oil also included anchovy fish meal. The following set of assumptions were utilized in the EPA and DHA calculations:

### For Anchovy Fish Meal:

1. Anchovy fish meal will be included in the final aquaculture feed formulation as 25% of the total feed on a weight basis;
2. Anchovy fish meal is assumed to have a total fat content of 6%;
3. One-quarter (25%) of the total fat content is assumed to be EPA and DHA;
4. For every 100 g of aquaculture feed formulation produced, 1.5% of the total aquaculture feed formulation on a weight basis is total fat content derived from anchovy fish meal (i.e., 0.25*6).
5. Since 25% of total fat content derived from anchovy fish meal in the aquaculture feed formulation is EPA and DHA, it is assumed that 0.375% of the total aquaculture feed formulation on a weight basis is EPA and DHA derived from the anchovy fish meal.
6. Of the Total EPA+DHA in Anchovy oil 72% is EPA and 28% is DHA.
7. Thus, for every 100 g of aquaculture feed formulation produced, 0.27% is EPA derived from the anchovy fish meal (i.e., 0.375%*0.72) and 0.1% is DHA derived from the anchovy fish meal (i.e., 0.375%*0.28).

### For Menhaden Fish Meal:

1. Menhaden fish meal will be included in the final aquaculture feed formulation as 25% of the total feed on a weight basis;
2. Menhaden fish meal is assumed to have a total fat content of 6%;
3. One-fifth (20%) of the total fat content is assumed to be EPA and DHA;
4. For every 100 g of aquaculture feed formulation produced, 1.5% of the total aquaculture feed formulation on a weight basis is total fat content derived from menhaden fish meal (i.e., 0.25*6).
5. Since 20% of total fat content derived from menhaden fish meal in the feed formulation is EPA and DHA, it is assumed that 0.30% of the total aquaculture feed formulation on a weight basis is EPA and DHA derived from the menhaden fish meal.
6. Of the Total EPA+DHA in Menhaden oil 55% is EPA and 45% is DHA.
7. Thus, for every 100 g of aquaculture feed formulation produced, 0.165% is EPA derived from the menhaden fish meal (i.e., 0.30%*0.55) and 0.135% is DHA derived from the menhaden fish meal (i.e., 0.30%*0.45).

Based on the assumptions above, it was possible to calculate the total EPA content, total DHA content and ratio of EPA:DHA in five different aquaculture feed formulations comprising anchovy oil (included as 0%, 2%, 5%, 10% or 20% of the total feed on a weight basis) and Yarrowia lipolytica Y4305 F1B1 biomass (included as 10%, 20% or 30% of the total aquaculture feed on a weight basis) (Table 8).

Similarly, total EPA content, total DHA content and ratio of EPA:DHA in five different aquaculture feed formulations comprising menhaden oil (included as 0%, 2%, 5%, 10% or 20% of the total aquaculture feed on a weight basis) and Yarrowia lipolytica Y4305 F1B1 biomass (included as 10%, 20% or 30% of the total aquaculture feed on a weight basis) were calculated (Table 9).

TABLE 8
EPA And DHA Content In Aquaculture Feed Formulations Comprising Variable
Concentrations Of Yarrowia Y4305 F1B1 Biomass (10%, 20% And 30%) And
Variable Concentrations Of Anchovy Oil (0%, 2%, 5%, 10% And 20%)

| % Yarrowia* | 30 | 30 | 30 | 30 | 30 | 20 | 20 | 20 | 20 | 20 |
|---|---|---|---|---|---|---|---|---|---|---|
| % EPA in | 4.50 | 4.50 | 4.50 | 4.50 | 4.50 | 3.00 | 3.00 | 3.00 | 3.00 | 3.00 |
| Yarrowia* | | | | | | | | | | |
| % DHA in | 0.00 | 0.00 | 0.00 | 0.00 | 0.00 | 0.00 | 0.00 | 0.00 | 0.00 | 0.00 |
| Yarrowia* | | | | | | | | | | |
| % anchovy oil | 0.00 | 2.00 | 5.00 | 10.00 | 20.00 | 0.00 | 2.00 | 5.00 | 10.00 | 20.00 |
| % EPA in | 0.00 | 0.34 | 0.84 | 1.68 | 3.35 | 0.00 | 0.34 | 0.84 | 1.68 | 3.35 |
| anchovy oil | | | | | | | | | | |
| % DHA in | 0.00 | 0.18 | 0.45 | 0.90 | 1.80 | 0.00 | 0.18 | 0.45 | 0.90 | 1.80 |
| anchovy oil | | | | | | | | | | |
| % Fish meal | 25.00 | 25.00 | 25.00 | 25.00 | 25.00 | 25.00 | 25.00 | 25.00 | 25.00 | 25.00 |
| % EPA in | 0.27 | 0.27 | 0.27 | 0.27 | 0.27 | 0.27 | 0.27 | 0.27 | 0.27 | 0.27 |
| Fish meal | | | | | | | | | | |
| % DHA in | 0.10 | 0.10 | 0.10 | 0.10 | 0.10 | 0.10 | 0.10 | 0.10 | 0.10 | 0.10 |
| Fish meal | | | | | | | | | | |
| Total EPA in | 4.77 | 5.11 | 5.61 | 6.45 | 8.12 | 3.27 | 3.61 | 4.11 | 4.95 | 6.62 |
| Formulation | | | | | | | | | | |
| Total DHA in | 0.10 | 0.28 | 0.55 | 1.00 | 1.90 | 0.10 | 0.28 | 0.55 | 1.00 | 1.90 |
| Formulation | | | | | | | | | | |
| Total EPA + | 4.87 | 5.39 | 6.16 | 7.45 | 10.02 | 3.37 | 3.89 | 4.66 | 5.95 | 8.52 |
| DHA in | | | | | | | | | | |
| Formulation | | | | | | | | | | |
| EPA:DHA | 47.70:1 | 18.25:1 | 10.20:1 | 6.45:1 | 4.27:1 | 32.70:1 | 12.89:1 | 7.47:1 | 4.95:1 | 3.48:1 |
| Ratio | | | | | | | | | | |

| % Yarrowia* | 10 | 10 | 10 | 10 | 10 |
|---|---|---|---|---|---|
| % EPA in | 1.50 | 1.50 | 1.50 | 1.50 | 1.50 |
| Yarrowia* | | | | | |
| % DHA in | 0.00 | 0.00 | 0.00 | 0.00 | 0.00 |
| Yarrowia* | | | | | |
| % anchovy oil | 0.00 | 2.00 | 5.00 | 10.00 | 20.00 |
| % EPA in | 0.00 | 0.34 | 0.84 | 1.68 | 3.35 |
| anchovy oil | | | | | |
| % DHA in | 0.00 | 0.18 | 0.45 | 0.90 | 1.80 |
| anchovy oil | | | | | |
| % Fish meal | 25.00 | 25.00 | 25.00 | 25.00 | 25.00 |
| % EPA in | 0.27 | 0.27 | 0.27 | 0.27 | 0.27 |
| Fish meal | | | | | |
| % DHA in | 0.10 | 0.10 | 0.10 | 0.10 | 0.10 |
| Fish meal | | | | | |
| Total EPA in | 1.77 | 2.11 | 2.61 | 3.45 | 5.12 |
| Formulation | | | | | |
| Total DHA in | 0.10 | 0.28 | 0.55 | 1.00 | 1.90 |
| Formulation | | | | | |
| Total EPA + | 1.87 | 2.39 | 3.16 | 4.45 | 7.02 |
| DHA in | | | | | |
| Formulation | | | | | |
| EPA:DHA | 17.70:1 | 7.54:1 | 4.75:1 | 3.45:1 | 2.69:1 |
| Ratio | | | | | |

*Yarrowia refers to Yarrowia lipolytica strain Y4305 F1B1 biomass.

TABLE 9
EPA And DHA Content In Aquaculture Feed Formulations Comprising Variable Concentrations
Of Yarrowia Y4305 F1B1 Biomass (10%, 20% And 30%) And Variable
Concentrations Of Menhaden Oil (0%, 2%, 5%, 10% And 20%)

| % Yarrowia* | 30 | 30 | 30 | 30 | 30 | 20 | 20 | 20 | 20 | 20 |
|---|---|---|---|---|---|---|---|---|---|---|
| % EPA in | 4.50 | 4.50 | 4.50 | 4.50 | 4.50 | 3.00 | 3.00 | 3.00 | 3.00 | 3.00 |
| Yarrowia* | | | | | | | | | | |
| % DHA in | 0.00 | 0.00 | 0.00 | 0.00 | 0.00 | 0.00 | 0.00 | 0.00 | 0.00 | 0.00 |
| Yarrowia* | | | | | | | | | | |
| % menhaden | 0.00 | 2.00 | 5.00 | 10.00 | 20.00 | 0.00 | 2.00 | 5.00 | 10.00 | 20.00 |
| oil | | | | | | | | | | |
| % EPA in | 0.00 | 0.22 | 0.54 | 1.08 | 2.16 | 0.00 | 0.22 | 0.54 | 1.08 | 2.16 |
| menhaden oil | | | | | | | | | | |
| % DHA in | 0.00 | 0.18 | 0.46 | 0.92 | 1.84 | 0.00 | 0.18 | 0.46 | 0.92 | 1.84 |
| menhaden oil | | | | | | | | | | |
| % Fish meal | 25.00 | 25.00 | 25.00 | 25.00 | 25.00 | 25.00 | 25.00 | 25.00 | 25.00 | 25.00 |
| % EPA in | 0.17 | 0.17 | 0.17 | 0.17 | 0.17 | 0.17 | 0.17 | 0.17 | 0.17 | 0.17 |
| Fish meal | | | | | | | | | | |
| % DHA in | 0.13 | 0.13 | 0.13 | 0.13 | 0.13 | 0.13 | 0.13 | 0.13 | 0.13 | 0.13 |
| Fish meal | | | | | | | | | | |
| Total EPA in | 4.67 | 4.89 | 5.21 | 5.75 | 6.83 | 3.17 | 3.39 | 3.71 | 4.25 | 5.33 |
| Formulation | | | | | | | | | | |
| Total DHA in | 0.13 | 0.31 | 0.59 | 1.05 | 1.97 | 0.13 | 0.31 | 0.59 | 1.05 | 1.97 |
| Formulation | | | | | | | | | | |
| Total EPA + | 4.80 | 5.20 | 5.80 | 6.80 | 8.80 | 3.30 | 3.70 | 4.30 | 5.30 | 7.30 |
| DHA in | | | | | | | | | | |
| Formulation | | | | | | | | | | |
| EPA:DHA | 35.92:1 | 15.77:1 | 8.83:1 | 5.48:1 | 3.47:1 | 24.38:1 | 10.94:1 | 6.29:1 | 4.05:1 | 2.71:1 |
| Ratio | | | | | | | | | | |

| % Yarrowia* | 10 | 10 | 10 | 10 | 10 |
|---|---|---|---|---|---|
| % EPA in | 1.50 | 1.50 | 1.50 | 1.50 | 1.50 |
| Yarrowia* | | | | | |
| % DHA in | 0.00 | 0.00 | 0.00 | 0.00 | 0.00 |
| Yarrowia* | | | | | |
| % menhaden | 0.00 | 2.00 | 5.00 | 10.00 | 20.00 |
| oil | | | | | |
| % EPA in | 0.00 | 0.22 | 0.54 | 1.08 | 2.16 |
| menhaden oil | | | | | |
| % DHA in | 0.00 | 0.18 | 0.46 | 0.92 | 1.84 |
| menhaden oil | | | | | |
| % Fish meal | 25.00 | 25.00 | 25.00 | 25.00 | 25.00 |
| % EPA in | 0.17 | 0.17 | 0.17 | 0.17 | 0.17 |
| Fish meal | | | | | |
| % DHA in | 0.13 | 0.13 | 0.13 | 0.13 | 0.13 |
| Fish meal | | | | | |
| Total EPA in | 1.67 | 1.89 | 2.21 | 2.75 | 3.83 |
| Formulation | | | | | |
| Total DHA in | 0.13 | 0.31 | 0.59 | 1.05 | 1.97 |
| Formulation | | | | | |
| Total EPA + | 1.80 | 2.20 | 2.80 | 3.80 | 5.80 |
| DHA in | | | | | |
| Formulation | | | | | |
| EPA:DHA | 12.85:1 | 6.10:1 | 3.75:1 | 2.62:1 | 1.94:1 |
| Ratio | | | | | |

*Yarrowia refers to Yarrowia lipolytica strain Y4305 F1B1 biomass.

### Example 5

### Alternate Strains of Yarrowia lipolytica Suitable for Aquaculture Feed Formulations

The purpose of this Example is to provide alternate microbial biomass that could be used as a source of EPA, for incorporation into an aquaculture feed formulation that supports production of an aquaculture meat product having an EPA:DHA ratio of 1.4:1 or greater than 1.4:1 based on the individual concentrations of EPA and DHA, each measured as a weight percent of the aquaculture meat product. One skilled in the art of aquaculture would readily be able to determine the appropriate amount of biomass (or, e.g., biomass and oil supplement) to include in the aquaculture feed formulation, to support production of the desired aquaculture meat product.

Although Examples 3 and 4 demonstrate production and use of aquaculture feed formulations including Yarrowia lipolytica Y4305 and Yarrowia lipolytica Y4305 F1B1 biomass, the present disclosure is by no means limited to aquaculture feed formulations comprising this particular biomass. Numerous other species and strains of oleaginous yeast genetically engineered for production of omega-3 PUFAs are suitable sources of microbial oils comprising EPA. As an example, one is referred to the representative strains of the oleaginous yeast Yarrowia lipolytica described in Table 10. These include the following strains that have been deposited with the ATCC: Y. lipolytica strain Y2096 (producing EPA; ATCC Accession No. PTA-7184); Y. lipolytica strain Y2201 (producing EPA; ATCC Accession No. PTA-7185); Y. lipolytica strain Y3000 (producing DHA; ATCC Accession No. PTA-7187); Y. lipolytica strain Y4128 (producing EPA; ATCC Accession No. PTA-8614); Y. lipolytica strain Y4127 (producing EPA; ATCC Accession No. PTA-8802); Y. lipolytica strain Y8406 (producing EPA; ATCC Accession No. PTA-10025); Y. lipolytica strain Y8412 (producing EPA; ATCC Accession No. PTA-10026); and, Y. lipolytica strain Y8259 (producing EPA; ATCC Accession No. PTA-10027).

Thus, for example, Table 10 shows microbial hosts producing from 4.7% to 61.8% EPA of total fatty acids, and optionally, 5.6% DHA of total fatty acids.

TABLE 10
Lipid Profiles of Representative Yarrowia lipolytica Strains Engineered to Produce Omega-3/Omega-6 PUFAs

| | | ATCC | Fatty Acid Content (As A Percent [%] of Total Fatty Acids) | | | | | | | | | | | | | | |
|---|---|---|---|---|---|---|---|---|---|---|---|---|---|---|---|---|---|
| | | Deposit | | | | | | 18:3 | | 20:2 | | | | | | | TFAs % |
| Strain | Reference | No. | 16:0 | 16:1 | 18:0 | 18:1 | 18:2 | (ALA) | GLA | (EDA) | DGLA | ARA | ETA | EPA | DPAn-3 | DHA | DCW |
| EU | U.S. Pat. | — | 19 | 10.3 | 2.3 | 15.8 | 12 | 0 | 18.7 | — | 5.7 | 0.2 | 3 | 10.3 | — | — | 36 |
| Y2072 | Appl. Pub. | — | 7.6 | 4.1 | 2.2 | 16.8 | 13.9 | 0 | 27.8 | — | 3.7 | 1.7 | 2.2 | 15 | — | — | — |
| Y2102 | No. 2006- | — | 9 | 3 | 3.5 | 5.6 | 18.6 | 0 | 29.6 | — | 3.8 | 2.8 | 2.3 | 18.4 | — | — | — |
| Y2088 | 0115881- | — | 17 | 4.5 | 3 | 2.5 | 10 | 0 | 20 | — | 3 | 2.8 | 1.7 | 20 | — | — | — |
| Y2089 | A1 | — | 7.9 | 3.4 | 2.5 | 9.9 | 14.3 | 0 | 37.5 | — | 2.5 | 1.8 | 1.6 | 17.6 | — | — | — |
| Y2095 | | — | 13 | 0 | 2.6 | 5.1 | 16 | 0 | 29.1 | — | 3.1 | 1.9 | 2.7 | 19.3 | — | — | — |
| Y2090 | | — | 6 | 1 | 6.1 | 7.7 | 12.6 | 0 | 26.4 | — | 6.7 | 2.4 | 3.6 | 26.6 | — | — | 22.9 |
| Y2096 | | PTA- | 8.1 | 1 | 6.3 | 8.5 | 11.5 | 0 | 25 | — | 5.8 | 2.1 | 2.5 | 28.1 | — | — | 20.8 |
| | | 7184 | | | | | | | | | | | | | | | |
| Y2201 | | PTA- | 11 | 16.1 | 0.7 | 18.4 | 27 | 0 | — | 3.3 | 3.3 | 1 | 3.8 | 9 | — | — | — |
| | | 7185 | | | | | | | | | | | | | | | |
| Y3000 | U.S. Pat. | PTA- | 5.9 | 1.2 | 5.5 | 7.7 | 11.7 | 0 | 30.1 | — | 2.6 | 1.2 | 1.2 | 4.7 | 18.3 | 5.6 | — |
| | No. | 7187 | | | | | | | | | | | | | | | |
| | 7,550,286 | | | | | | | | | | | | | | | | |
| Y4001 | U.S. Pat. | — | 4.3 | 4.4 | 3.9 | 35.9 | 23 | 0 | — | 23.8 | 0 | 0 | 0 | — | — | — | — |
| Y4036 | Appl. Pub. | — | 7.7 | 3.6 | 1.1 | 14.2 | 32.6 | 0 | — | 15.6 | 18.2 | 0 | 0 | — | — | — | — |
| Y4070 | No. 2009- | — | 8 | 5.3 | 3.5 | 14.6 | 42.1 | 0 | — | 6.7 | 2.4 | 11.9 | — | — | — | — | — |
| Y4086 | 0093543- | — | 3.3 | 2.2 | 4.6 | 26.3 | 27.9 | 6.9 | — | 7.6 | 1 | 0 | 2 | 9.8 | — | — | 28.6 |
| Y4128 | A1 | PTA- | 6.6 | 4 | 2 | 8.8 | 19 | 2.1 | — | 4.1 | 3.2 | 0 | 5.7 | 42.1 | — | — | 18.3 |
| | | 8614 | | | | | | | | | | | | | | | |
| Y4158 | | — | 3.2 | 1.2 | 2.7 | 14.5 | 30.4 | 5.3 | — | 6.2 | 3.1 | 0.3 | 3.4 | 20.5 | — | — | 27.3 |
| Y4184 | | — | 3.1 | 1.5 | 1.8 | 8.7 | 31.5 | 4.9 | — | 5.6 | 2.9 | 0.6 | 2.4 | 28.9 | — | — | 23.9 |
| Y4217 | | — | 3.9 | 3.4 | 1.2 | 6.2 | 19 | 2.7 | — | 2.5 | 1.2 | 0.2 | 2.8 | 48.3 | — | — | 20.6 |
| Y4259 | | — | 4.4 | 1.4 | 1.5 | 3.9 | 19.7 | 2.1 | — | 3.5 | 1.9 | 0.6 | 1.8 | 46.1 | — | — | 23.7 |
| Y4305 | | — | 2.8 | 0.7 | 1.3 | 4.9 | 17.6 | 2.3 | — | 3.4 | 2 | 0.6 | 1.7 | 53.2 | — | — | 27.5 |
| Y4127 | Int'l. App. | PTA- | 4.1 | 2.3 | 2.9 | 15.4 | 30.7 | 8.8 | — | 4.5 | 3.0 | 3.0 | 2.8 | 18.1 | — | — | — |
| | Pub. No. | 8802 | | | | | | | | | | | | | | | |
| Y4184 | WO | — | 2.2 | 1.1 | 2.6 | 11.6 | 29.8 | 6.6 | — | 6.4 | 2.0 | 0.4 | 1.9 | 28.5 | — | — | 24.8 |
| | 2008/ | | | | | | | | | | | | | | | | |
| | 073367 | | | | | | | | | | | | | | | | |
| Y8406 | U.S. Pat. | PTA- | 2.6 | 0.5 | 2.9 | 5.7 | 20.3 | 2.8 | — | 2.8 | 2.1 | 0.5 | 2.1 | 51.2 | — | — | 30.7 |
| | Appl. Pub. | 10025 | | | | | | | | | | | | | | | |
| Y8412 | No. 2010- | PTA- | 2.5 | 0.4 | 2.6 | 4.3 | 19.0 | 2.4 | — | 2.2 | 2.0 | 0.5 | 1.9 | 55.8 | — | — | 27.0 |
| | 0317072- | 10026 | | | | | | | | | | | | | | | |
| Y8647 | A1 | — | 1.3 | 0.2 | 2.1 | 4.7 | 20.3 | 1.7 | — | 3.3 | 3.6 | 0.7 | 3.0 | 53.6 | — | — | 37.6 |
| Y9028 | | — | 1.3 | 0.2 | 2.1 | 4.4 | 19.8 | 1.7 | — | 3.2 | 2.5 | 0.8 | 1.9 | 54.5 | — | — | 39.6 |
| Y9481 | | — | 2.5 | 0.5 | 3.1 | 4.7 | 11.0 | 0.6 | — | 2.6 | 3.6 | 0.9 | 2.1 | 60.9 | — | — | 35.0 |
| Y9502 | | — | 2.5 | 0.5 | 2.9 | 5.0 | 12.7 | 0.9 | — | 3.5 | 3.3 | 0.8 | 2.4 | 57.0 | — | — | 37.1 |
| Y8145 | | — | 4.3 | 1.7 | 1.4 | 4.8 | 18.6 | 2.8 | — | 2.2 | 1.5 | 0.6 | 1.5 | 48.5 | — | — | 23.1 |
| Y8259 | | PTA- | 3.5 | 1.3 | 1.3 | 4.8 | 16.9 | 2.3 | — | 1.9 | 1.7 | 0.6 | 1.6 | 53.9 | — | — | 20.5 |
| | | 10027 | | | | | | | | | | | | | | | |
| Y8367 | | — | 3.7 | 1.2 | 1.1 | 3.4 | 14.2 | 1.1 | — | 1.5 | 1.7 | 0.8 | 1.0 | 58.3 | — | — | 18.4 |
| Y8672 | | — | 2.3 | 0.4 | 2.0 | 4.0 | 16.1 | 1.4 | — | 1.8 | 1.6 | 0.7 | 1.1 | 61.8 | — | — | 26.5 |

1. An aquaculture meat product comprising a ratio of eicosapentaenoic acid (“EPA”) to docosahexanoic acid (“DHA”) that is equal to or greater than 1.4 to 1, based on the individual concentrations of EPA and DHA in the aquaculture meat product.

2-10. (canceled)

11. A sustainably, farm-raised fish meat product having a ratio of eicosapentaenoic acid (EPA) to docosahexaenoic acid (DHA) that is equal to or greater than 1.4 to 1, wherein said ratio is based on the individual concentrations of the EPA and DHA in the fish meat product, and further wherein said fish meat product is obtained from fish fed an aquaculture feed composition comprising microbial oil having at least 50% EPA of the total fatty acids of the microbial oil, wherein the microbial oil is a partial or total replacement for fish oil in the aquaculture feed composition.

12. The fish meat product of claim 11, wherein the microbial oil is comprised within yeast biomass.

13. The fish meat product of claim 12, wherein the yeast biomass is Yarrowia lipolytica biomass.

14. The fish meat product of claim 11, wherein there is 1.2% or less of DHA in the total fatty acids of the aquaculture feed composition.

15. The fish meat product of claim 11, wherein the ratio of EPA to DHA is equal to or greater than 1.5 to 1.

16. The fish meat product of claim 11, wherein the sum of the EPA and DHA is at least 0.5 weight percent of the aquaculture meat product.

17. The fish meat product of claim 11, wherein the fish meat product is salmon meat.

18. The fish meat product of claim 17, wherein salmon meat is Atlantic salmon meat.

19. The fish meat product of claim 17, wherein salmon meat is coho salmon meat.

20. A method of sustainably producing a farm-raised fish meat product, said method comprising:
a) providing an aquaculture feed comprising Yarrowia lipolytica biomass;
b) feeding the aquaculture feed to farm-raised fish; and
c) harvesting meat from the farm-raised fish;
wherein the ratio of EPA to DHA in the meat is equal to or greater than 1.4 to 1, wherein said ratio is based on the individual concentrations of the EPA and DHA in the meat.
